(19) United States
(12) Patent Application Publication
(10) Pub. No.: US 2026/0006682 A1
(43) Pub. Date: Jan. 1, 2026

(54) SYSTEM AND METHOD OF CORELESS RADIO ACCESS NETWORK NODES

(71) Applicant: JIO PLATFORMS LIMITED, Ahmedabad (IN)

(72) Inventors: Satish JAMADAGNI, Bangalore (IN); Mahesh NAYAKA MYSORE ANNAIAH, Bengaluru (IN); Pradeep HIRISAVE, Bengaluru (IN); Mathew OOMMEN, Plano, TX (US)

(73) Assignee: JIO PLATFORMS LIMITED, Ahmedabad (IN)

(21) Appl. No.: 19/144,799

(22) PCT Filed: Dec. 30, 2023
(86) PCT No.: PCT/IB2023/063407

§ 371 Date: Jun. 30, 2025

(30) Foreign Application Priority Data
Dec. 31, 2022 (IN) 202221077542

(51) Int. Cl. H04W 76/40; H04W 48/10; H04W 76/12

(52) U.S. Cl. CPC H04W 76/40; H04W 48/10; H04W 76/12

(57) ABSTRACT

The present disclosure provides a system and a method for enabling a coreless network architecture by proposing a Radio Access Network (RAN) node for providing network coverage and services to User Equipment (UE) while not being connected or dependent on the core network. In an embodiment, the RAN node may be a mobile RAN node that forms a part of a fleet to provide network coverage and services to UEs at any geolocation as per the requirement. The disclosure also proposes mechanisms for the mobile RAN nodes to communicate amongst each other and also intermittently with the core network and data network (ISP) when available.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The embodiments of the present disclosure generally relate to systems and methods for providing sixth generation (6G) coreless architecture. More particularly, the present disclosure relates to systems and methods for providing a radio access network (RAN) architecture that can work without a core network.

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

Fifth Generation (5G) communication, which has many more features than fourth-generation communication, has been launched in many countries. A new paradigm of wireless communication, the Sixth Generation (6G) system, with full support of artificial intelligence (AI) is expected to be deployed in the next decade or so. In beyond 5G network implementations (e.g., 6G systems), there may be some fundamental issues, which need to be addressed. Such network issues include higher system capacity, higher data rate, lower latency. and improved quality of service (QOS) compared to 5G systems.

The 5G wireless technology that was developed in 3GPP is meant to deliver higher multi-Gbps peak data speeds, ultra-low latency, more reliability, massive network capacity, increased availability, and a more uniform user experience to higher number of users. Higher performance and improved efficiency empower new user experiences and connects newer industries. Some of the above objectives have been met but there are still quite a few issues that need to be resolved especially when it comes to accommodating industry verticals, architectures to support private networks and support flexible network deployments etc. All aspects of network coverage and service involves a heavy dependency on the core network and poses limitations to solutions to the above problems. Also, stationary nature of RAN nodes poses further limitations to network flexibility and service options in 5G/6G networks.

Therefore, there is a well-felt need for a 5G/6G network architecture that can address the issue of network flexibility and at least the above-mentioned issues. Specifically, there is a well-felt need for a coreless mode of RAN operation and a mobile RAN node that provides network coverage/services during the coreless mode of operation.

There is, therefore, a need in the art to provide a system and a method that can mitigate the problems associated with the prior arts.

### OBJECTS OF THE PRESENT DISCLOSURE

Some of the objects of the present disclosure, which at least one embodiment herein satisfies are listed herein below.

It is an object of the present disclosure to support a coreless RAN functionality which can better support mobile radio access operations and be used in 6G network architecture as a fundamental building block.

It is an object of the present disclosure to provide for a fleet of mobile RAN nodes or UAVs that communicate amongst themselves to provide network coverage and services to UEs.

It is an object of the present disclosure to provide a mechanism for inter RAN node communication in a coreless mode of operation for mobile RAN nodes/UAVs.

It is an object of the present disclosure to provide network facility in all terrains.

### SUMMARY

Aspects of the present disclosure generally relate to systems and methods for providing sixth generation (6G) coreless architecture. More particularly, the present disclosure relates to a system and a method for providing a radio access network (RAN) architecture that can work without a core network.

In an aspect, a system for broadcasting connection status between Radio Access Networks (RAN) node and core network (CN) includes one or more processors, and a memory operatively coupled to the one or more processors, the memory having one or more processor-executable instructions, which, when executed, cause the one or more processors to retrieve a connection schedule data indicative of a schedule of when the system connects to a CN, and periodically broadcast the connection schedule data in a set of dedicated signals to one or more user equipment (UEs).

In another aspect, a user equipment (UE) includes one or more processors, and a memory operatively coupled to the one or more processors, the memory having one or more processor-executable instructions, which, when executed, cause the one or more processors to receive a set of dedicated signals from a Radio Access Network (RAN) node, and establish a communication channel with the RAN node based on connection schedule data provided in the set of dedicated signals.

In yet another aspect, a Radio Access Network (RAN) node for providing services to User Equipment (UEs) includes a Uu stack having a Radio Frequency (RF) unit configured to exchange radio signals with one or more UEs that request services from the RAN node, an inter-RAN node interface configured to communicate with other RAN nodes, and a local Core Network (CN) configured to process operational data associated with the one or more UEs and communicate with the one or more UEs using the Uu stack, wherein the local CN may be configured to communicate with the other RAN nodes using the inter-RAN node interface to exchange the operational data required to provide the services to the one or more UEs.

In some embodiments, the local CN may include a local CN control plane (CP) configured to process the operational data to provide the services to the one or more UEs, and a local CN user plane (UP) configured to receive and transmit the operational data between the local CN CP of the RAN node, and the one or more UEs, other RAN nodes, or a CN.

In some embodiments, the RAN node may include a local CN UP cache configured to store the operational data for providing the services to the one or more UEs, and wherein when the operational data required for providing the services to the one or more UEs may be unavailable at the local CN UP cache, the RAN node may be configured to retrieve the unavailable operational data from a master RAN node having a fully updated database of operational data and store the operational data in the local CN CP cache.

In some embodiments, when the RAN node may be a master RAN node, the RAN node has a fully updated database of operational data, and wherein the RAN node may be configured to, receive an operational data request from one or more assistive RAN nodes for retrieving the operational data associated with the one or more UEs, retrieve the requested operational data from the fully updated database of operational data, and transmit the requested operational data in an operational data response to the one or more assistive RAN nodes.

In some embodiments, the RAN node may be configured to transmit, by the Uu stack, an operational data request to a master RAN node using a directed radio beam.

In some embodiments, the inter RAN interface of the RAN node and the inter RAN interface of the other RAN nodes exchange an operational data request and an operational data response via a Radio Resource Control (RRC) protocol.

In some embodiments, the RAN node may include a transportation means configured to allow the RAN node to move from a first geolocation to a second geolocation, wherein the local CN may be configured to cause the RAN node to move from the first geolocation to the second geolocation when the RAN node may be in the first geolocation and requires the operational data available at other RAN nodes at the second geolocation.

In some embodiments, the RAN node may include a management plane having, a Local Dynamic Map (LDM) configured to store any of, topographical, positional, and status data associated with a geographical region, and a management interface configured to transmit and receive the LDM data, wherein the management plane may be configured to determine availability of other RAN nodes.

In some embodiments, the management plane may be configured to determine if a master RAN node may be within a predetermined threshold distance from the RAN node using the data stored in the LDM.

In some embodiments, RAN node may include a CN interface (I/F) configured to operably connect and communicate with a CN when the RAN node may be connected to the CN, wherein the RAN node may be configured to transmit or receive the operational data from the CN.

In some embodiments, the RAN node, using the CN interface, may be configured to transmit a set of update signals having operational data associated with the one or more UEs to the CN, wherein the operational data may include UE contexts associated with each of the one or more UEs, receive a set of verification signals from the CN, the set of verification signals having a set of verified UEs from the one or more UEs if authenticated by the CN, establish a session for each UE in the set of verified UEs, and exchange the operational data associated the set of verified UEs to the CN.

In still another aspect, a Security Edge Protection Proxy (SEPP) system, may include, one or more RAN nodes each having one or more processors, a memory operatively coupled to the one or more processors, the memory having one or more processor-executable instructions, which, when executed, cause the one or more processors to, validate identity of other RAN nodes with which communication may be sought, and on successful validation. establish a communication channel between the RAN node and the other RAN nodes.

In some embodiments, the communication channel may be any one of, Xn interface, or an Integrated Access Backhaul (IAB) interface.

In other aspects, a method for communication between one or more Radio Access Network (RAN) nodes includes determining, by a RAN node, a first geolocation corresponding to a master RAN node, transmitting, by the RAN node, a set of request signals to the master RAN node to retrieve operational data required to provide services to one or more User Equipment (UE), receiving, by the RAN node, a set of response signals containing the operational data from the master RAN node, and processing, by the RAN node, the operational data to provide one or more services to the one or more UEs.

In still other aspects, a method for exchanging operational data between a Core Network (CN) and a Radio Access Network (RAN) node includes determining, by a RAN node, if the RAN node may be connected to the CN, transmitting, by the RAN node, a set of update signals having operational data associated with one or more User Equipment (UEs) to the CN, wherein the operational data may include UE contexts associated with each of the one or more UEs, receiving, by the RAN node, a set of verification signals from the CN, the set of verification signals having a set of verified UEs from the one or more UEs successfully authenticated by the CN, establishing, by the RAN node, a session for each UE in the set of verified UEs, and exchanging, by the RAN node, the operational data associated the set of verified UEs to the CN.

In another aspect, the present disclosure relates to a non-transitory computer-readable medium including processor-executable instructions which cause a processor to perform the steps of the methods herein.

Various objects, features, aspects, and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1A illustrates an exemplary existing 5G network architecture (100), in accordance with an embodiment of the present disclosure.

FIGS. 1B, 1C, and 1D illustrate exemplary network architecture scenarios in accordance with an embodiment of the present disclosure.

FIG. 2 illustrates an exemplary scenario (200) involving mobile RANs, such as UAVs, and UEs, and immobile RAN nodes, such as next-generation base station (NgNBs), in accordance with an embodiment of the present disclosure.

FIG. 3 illustrates an exemplary communication (300) from the RAN node publishing indicating if it is in the connected mode or the coreless mode, in accordance with an embodiment of the present disclosure.

FIG. 4 illustrates an exemplary communication (400) from the UE (104) and associated mechanism for the UE (104) to query a RAN node if it is in a coreless or a connected mode, in accordance with an embodiment of the present disclosure.

FIG. 5 illustrates an exemplary mechanism (500) of an independent RAN node that provides services to the UEs (104) independently of the CN, in accordance with an embodiment of the present disclosure.

FIG. 6 illustrates an exemplary independent node architecture (600), in accordance with an embodiment of the present disclosure.

FIG. 7 illustrates an exemplary scenario (700) of a mobile RAN node, such as UAV (702), at various time instances at different geo locations, in accordance with an embodiment of the present disclosure.

FIG. 8 illustrates an example scenario (800) of a master RAN node and two assistive RAN nodes catering to different geolocations at the same time instant, in accordance with an embodiment of the present disclosure.

FIG. 9 illustrates an exemplary scenario (900) for control information exchange between a master UAV and an assistive UAV via an enhanced Xn interface/inter RAN node interface, in accordance with an embodiment of the present disclosure.

FIG. 10 illustrates yet another scenario (1000) for control information exchange between a master UAV and an assistive UAV via the enhanced Xn interface/inter RAN node interface, in accordance with an embodiment of the present disclosure.

FIG. 11 illustrates an exemplary scenario (1100) in which an assistive UAV moves towards master UAV's coverage due to lack of operational data to provide services to some of its users, in accordance with an embodiment of the present disclosure.

FIG. 12A illustrates an exemplary set of steps (1200) executed by master UAV and assistive UAV when the assistive UAV moves towards a geolocation coverage of the master UAV, in accordance with an embodiment of the present disclosure.

FIGS. 12B and 12C illustrate scenarios (1220) where assistive UAV decides to connect with master UAV, in accordance with an embodiment of the present disclosure.

FIG. 12D illustrates an exemplary flight schedule (1240) configured for all master and assistive UAVs in a particular geographic location, in accordance with an embodiment of the present disclosure.

FIG. 13 illustrates an exemplary method (1300) for providing network coverage and services by a RAN node, such as an assistive UAV, for a requested geolocation, in accordance with an embodiment of the present disclosure.

FIG. 14 illustrates a signal flow diagram (1400) that includes exemplary communication between various modules/components of master UAV and assistive UAV respectively for obtaining subscription, in accordance with an embodiment of the present disclosure.

FIG. 15 illustrates a signal flow diagram (1500) for an exemplary docking procedure for UAV or a mobile RAN node to offload data once a core network or an ISP becomes available using additional new N32/N9 messages, in accordance with an embodiment of the present disclosure.

FIGS. 16A-F illustrate example use cases (1600, 1610, 1620, 1630, 1640, 1650) for realizing Inter-RAN node interface between master and assistive UAVs, in accordance with an embodiment of the present disclosure.

FIG. 17 illustrates a method (1700) for establishing an Inter-RAN node interface between assistive UAV and master UAV, in accordance with an embodiment of the present disclosure.

FIG. 18 illustrates an exemplary representation of a proposed system (1800) for providing a 6G coreless architecture, in accordance with an embodiment of the present disclosure.

FIG. 19 illustrates a general computing system (1900), in accordance with an embodiment of the present disclosure.

The foregoing shall be more apparent from the following more detailed description of the disclosure.

### DETAILED DESCRIPTION OF THE PRESENT DISCLOSURE

In the following description, for explanation, various specific details are outlined in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a,” “an,” and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items.

The fifth generation (5G) network architecture includes Radio Access Network (RAN) nodes and core network functions that are tightly coupled. Decoupling the RAN nodes from the core networks where device authentication/authorization, among other network operations/functions, can become independent of the core network is one of the objectives of the current disclosure. Such an implementation can support coreless RAN functionality which can better support mobile access systems, such as Unmanned Aerial Vehicles (UAV) based RANs, and can be used in sixth generation (6G) network architecture as a fundamental building block.

The foundations of 5G Core architecture have been specified in 3GPP Release 15. The 5G core is implemented as a fully Service-Based Architecture (SBA) with new service-based interfaces (SBIs) and, therefore, decouples service consumer from producer. Service-Based Architectures provide a modular framework from which common applications can be deployed using components of varying sources and suppliers. For example, the 3GPP defines a Service-Based Architecture (SBA), whereby the control plane functionality and common data repositories of a 5G network are delivered by way of a set of interconnected Network Functions (NFs), each with authorization to access each other's services. Further, the 5G core supports many new capabilities such as, but not limited to, improved session management to enable session and service continuity by the “make before break” option, which is essential for ultra-reliable low latency (URLLC) use cases. The other capabilities include flow-based Quality of service (QOS) framework assuring QoS on an application level, flexible end-to-end and seamless network slicing across RAN, the core and the transport network with User Equipment (UE) being able to simultaneously access more than one slice.

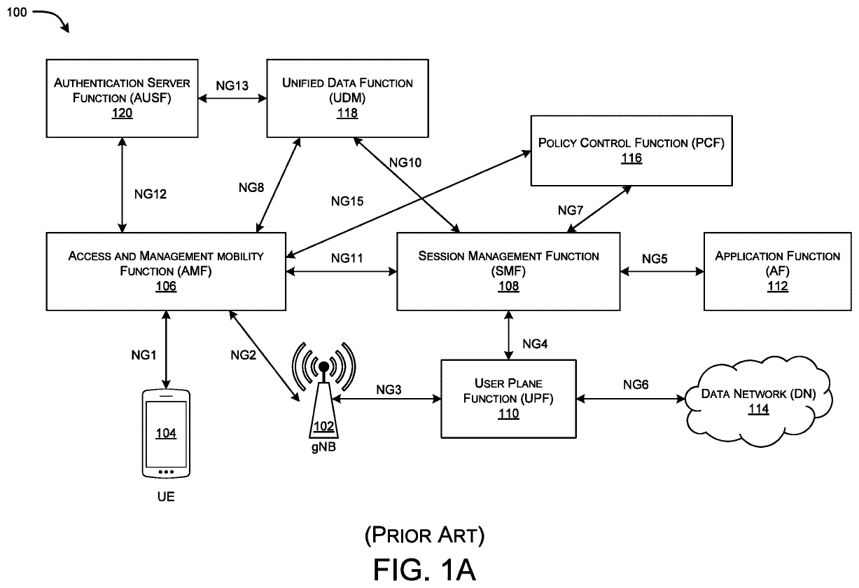

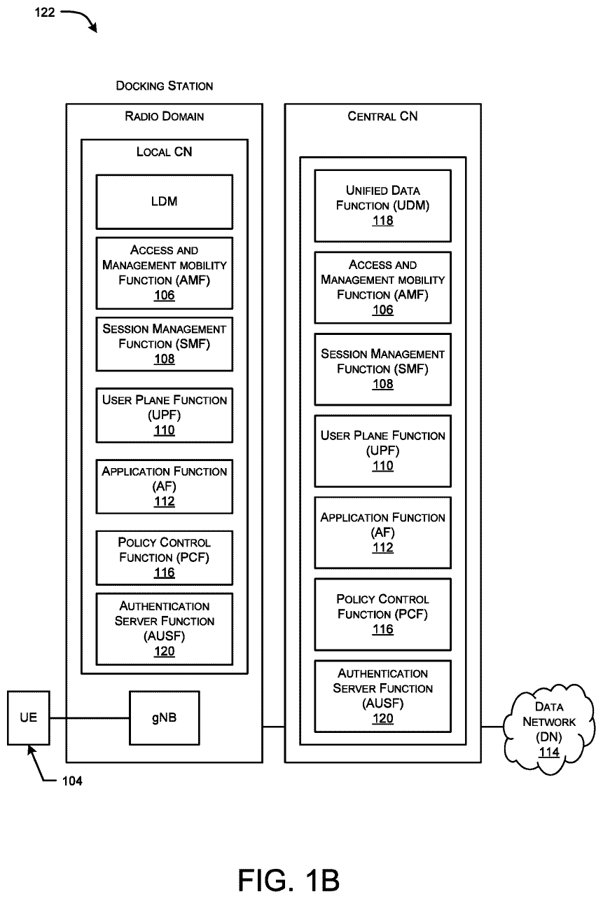

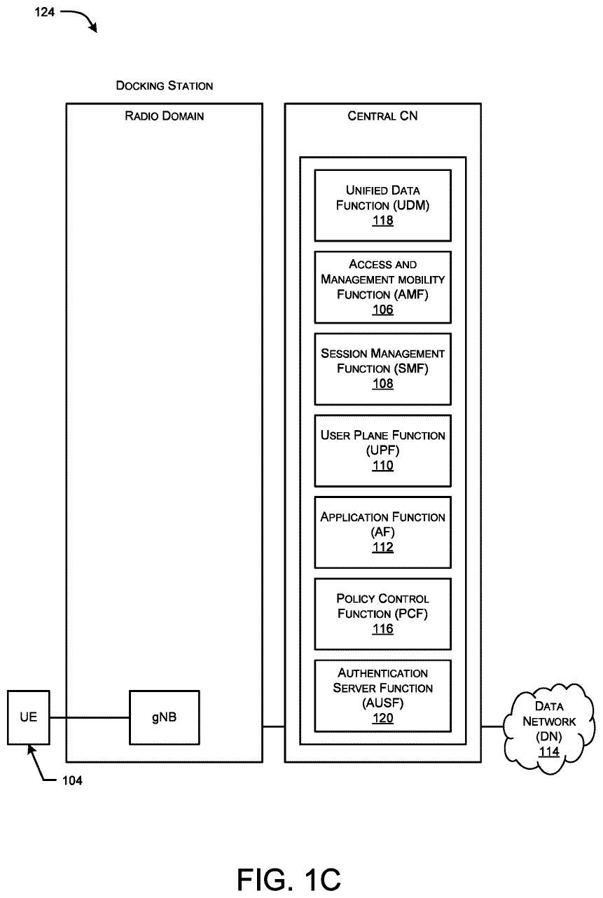

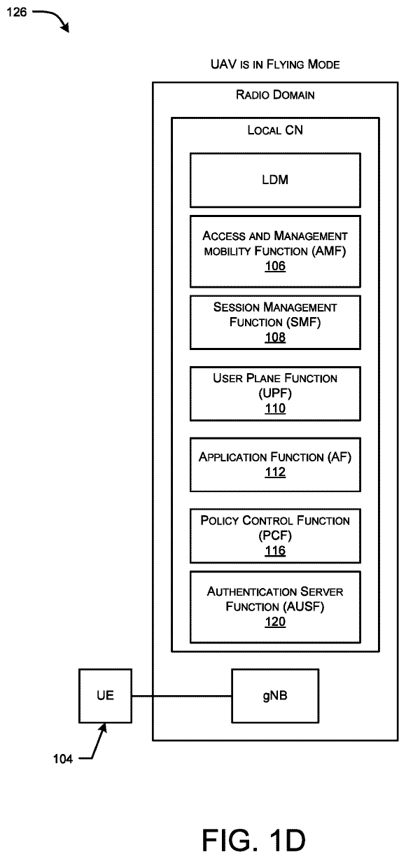

Further, as shown on in FIG. 1, the existing 5G network architecture (100) includes a UE (104), Next Gen Node Base station (NgNB) (102), and a core network having a Core Access and Mobility Management Function (AMF) (106) that is responsible for termination of RAN Control Plane interface, Non-Access Stratum (NAS) ciphering and integrity protection, Mobility Management, and Access Authentication and Authorization, which acts as a Security Anchor Function (SEAF), among other network functions. The AMF (106) also interacts with the Unified Data Management (UDM) (118) and the UE (104) as part of the UE authentication process. The AMF (106) is also responsible for the Security Context Management (SCM).

The existing network architecture (100) further includes Session Management Control Function (SMF) (108) that manages the sessions, the UE Internet Protocol (IP) address allocation & management (including optional Authorization), selection and control of User Plane Function (UPF) (110), the termination of interfaces towards policy control and charging functions which allows the control part of policy enforcement and QoS. The charging functions also handles the roaming functionality, handles local enforcement to apply QOS SLAs (such as Visited Public Land Mobile Network (VPLMN)) and charging data collection and charging interface (VPLMN).

Further the network architecture (100) includes UPF (110) of the core network that performs the functions including QoS handling, Packet routing & forwarding, Packet inspection and Policy rule enforcement, Traffic accounting and reporting and act as an anchor point for Intra-/Inter-Radio Access Technology (RAT) mobility (when applicable).

Further, the network architecture (100) includes Application Function (AF) (112) that provides application services to subscribers/users. Further, the network architecture (100) includes Data Network (DN) (114) that handles the operator services, internet access or other services. Further, the network architecture (100) includes Policy Control Function (PCF) (116) that provides support of unified policy framework to govern network behaviours. Further, the network architecture (100) includes UDM (118) that supports Authentication Credential Repository and Processing Function (ARPF). This function stores the long-term security credentials used in authentication under Authentication and Key Agreement (AKA) protocol, helps in Storing of Subscription information. Additionally, the network architecture (100) includes Authentication Server Function (AuSF) (120) that performs authentication processes with the UE (104).

As described above, one of the key requirements for 6G network architecture is the support for coreless networks which can help in access through mobile nodes (e.g., UAVs as base stations) i.e., the RAN nodes will have to work independent of the core network. The disclosure proposes an architecture for a 6G RAN that can function independent of the core network. The disclosure provides scenarios when one or more mobile RANs can work independently of the core network, and in some scenarios may intermittently connect to the core network from time to time for, among other operations, offload data connected.

In some embodiments, the UE (104) may also be made aware of the procedures to use if a RAN node is connected to the core network or not. In some embodiments, the present disclosure supports mechanisms where the RAN node indicates that there is no core support or where the UE (104) may be configured to query the RAN node to know if a core network is available.

6G networks are expected to provide novel radio and access architecture for both communications and sensing purposes. AI-optimized wide area network (WAN) and data center co-design, as well as dynamic orchestration of personalized services to revolutionize the long tail of niche consumer interests. While demand for mobile broadband will continue to increase for consumers and enterprises alike, uptake of ultra-reliable and low latency will be largely driven by specialized and local use cases in conjunction with non-public networks, and often with augmented intelligence. Such growth will happen as an integral part of automated and secure network transformation. In some embodiments, objects ranging from cars, industrial machines, and appliances to watches and apparel, may learn and organize themselves to fulfil our needs by automatically adapting to our behaviour, environment, and business processes. Energy efficiency is another key design criterion for the design of 6G network architectures since performance of the network will depend on the energy available in the respective architectural domains.

One of the most challenging requirements in 6G network architecture is associated with remote control in conjunction with augmented reality (AR) and immersive media experience. In addition to extreme URLLC performance requirement, a solution to such a requirement would demand ultra-high rates of say 100 Gbit/s or higher allowing uncompressed transmission of high quality 360-degree video. This will necessitate a degree of flexibility and specialization beyond the existing 5G network capabilities. 6G networks must, therefore, be “intent” and “open service” driven and, in short, business needs will drive the future 6G product and service offerings. Product and service creation will be an integral part of the automated exchange to exchange (E2E) service workflow which is steered and guided by policy and intent. In other words, use case driven network means a network that is configured to meet the diverse needs and preferences of each user or specialized 6G sub-network, whether human, physical machine or digital twin. Additionally, 6G network also proposes use of mobile RAN nodes that allow for easy and dynamic deployment regardless of the geography or terrain of a specific region, for instance in cities having high densities where base stations are difficult to install, remote locations where resources for building base stations are difficult to procure, dynamically allocating radio resources based on network traffic/demand such as during events/concerts, etc. In summary, the key requirements for 6G network architecture may include (a) network programmability; (b) deployment flexibility; (c) simplicity and efficiency; (d) security, robustness, and reliability; and (e) automation.

The present disclosure also addresses the issue of decoupling the RAN Access nodes from the core networks where authentication/authorization of UEs (104), among other network operations/services, provided to the UEs (104), can become independent of the core network. The objective of the present disclosure is to support a coreless RAN functionality which can better support the UE (104) based radio access operations and be used in 6G network architecture as a fundamental building block.

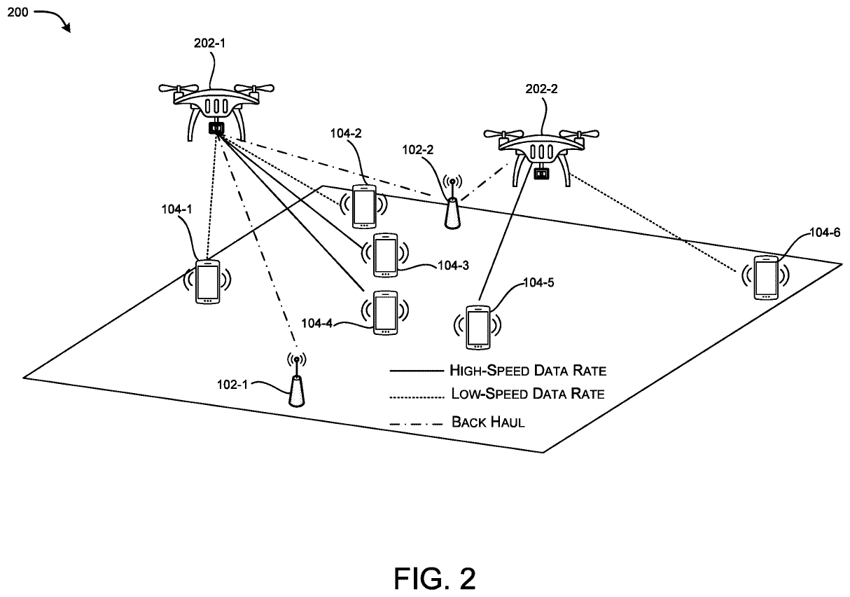

The present disclosure addresses the aforementioned issues by providing a coreless RAN network having one or more RAN nodes that are capable of operating that may be mobile or immobile. In embodiments where the RAN node is mobile, the RAN node may be implemented on including, but not limited to, UAVs, vehicles such as cars, buses, trains/public transport, boats, ships, satellites, and the like. In other embodiments, where the coreless RAN is immobile, the RAN may be indicative of local/traditional base stations that are disconnected from the core network, but may be capable of intermittently communicating with the core network. The various embodiments throughout the disclosure will be explained in more detail with reference to FIGS. 2-19.

FIGS. 1B, 1C, and 1D illustrate exemplary network architecture scenarios in accordance with an embodiment of the present disclosure. For example, FIG. 1B shows a scenario (122) in which a docking station for connecting the RAN node with the core network is depicted. The radio domain/RAN node may include a local core network (CN) that further includes LDM that further includes one or more network functions/entities such as including, but not limited to, an AMF (106), a SMF (108), a UPF (110), an AF (112), a PCF (116), and an AuSF (120). The local CN may further include gNB/RAN node (102) that is configured to allow radio communication with one or more UEs (104). The local CN may be in communication with UEs (104), and may be configured to perform network functions/operations, and provide services to the UEs (104). In embodiments shown in FIG. 1B, the local CN may be connected to a central CN that in turn is in communication with the data network (114). In an embodiment, the central CN may also include a corresponding set of network functions/entities, such as AMF (106), SMF (108), UPF (110), AF (112), PCF (116), UDM (118), and AuSF (120). It may be appreciated that the core network functionalities are split into the local CN and the central CN. In an embodiment, when the RAN node, such as the UAV, is at the docking station or is in a “docking mode”/“connected mode”, and the RAN node may have no network function blocks and may be in communication with the central CN that implements all the network function blocks (e.g., AMF (106), SMF (108), UPF (110), AF (112), PCF (116), UDM (118), and AuSF (120)), as shown in FIG. 1C. When the UAV is not at the docking station and is in a “flight mode”/“coreless mode”, then the RAN node may implement in the local CN (and the network entities thereof), and provides the core network functionalities to the UE (104) as shown in FIG. 1D.

FIG. 2 illustrates an exemplary scenario (200) involving mobile RANs, such as UAVs. and UEs (104), and immobile RAN nodes, such as next-generation base station (NgNBs), in accordance with an embodiment of the present disclosure. As illustrated in FIG. 2, one or more computing devices (104-1, 104-2, 104-3, 104-4), herein referred to as computing devices (104) may be in communication with a first UAV (202-1). Similarly, the computing devices (104-5 and 104-6) may be in communication with a second UAV (202-2). The first and the second UAVs (202-1, 202-2) may be indicative of examples of mobile RAN nodes, and it may be appreciated by those skilled in the art that the UAVs may be suitably replaced with other mobile RAN nodes based on requirements without losing functionality thereof. The computing devices (104) may include, but not be limited to, a mobile phone, smartphone, virtual reality (VR) devices, augmented reality (AR) devices, a laptop, a general-purpose computer, a desktop, a personal digital assistant, a tablet computer, a mainframe computer, etc. Further, the computing devices (104) may include one or more in-built or externally coupled accessories including, but not limited to, a visual aid device such as a camera, audio aid, microphone, or keyboard. Additionally, input devices for receiving input from a user such as a touchpad, touch-enabled screen, electronic pen, and the like may be used. It may be appreciated that the terms “computing device” and “user equipment (UE)” may be used interchangeably throughout the disclosure. Although a certain number of UEs or computing devices are depicted in FIG. 2, it may be appreciated that any number of UEs may be implemented without departing from the scope of the present disclosure.

As shown in FIG. 2, the first UAV (202-1) may be in communication with a first gNB (102-1) and a second gNB (102-2) (hereinafter interchangeably referred to as NgNB, gNBs or immobile RAN nodes). The second UAV (202-2) may be in communication with the second gNB (102-2). The UAVs (202-1, 202-2) may be collectively referred to as UAVs (202), and the gNBs (102-1, 102-2) may be collectively referred to as gNBs (102). The UEs (104) may establish a connection with the UAVs (202) or gNBs (102) through a network (not shown). The UAVs (202) may be configured to support high-speed data rate and low-speed data rate for UEs (104) using a backhaul link with the gNBs (102). As shown, each of the UAVs (202-1, 202-2) may provide network services for different geolocation coverages. One or more gNBs (102) may be connected with the same UAV (e.g., 202-1) to provide a backhaul link therebetween.

In some embodiments, the UAVs (202) and the gNBs (102) may be Radio Access Technologies (RATs) configured to provide telecommunication services to the UEs (104). In some embodiments, the UAVs (202) and the gNBs (102) may be configured to receive and transmit radio signals to and from the UEs (104) for providing services to the UEs (104). The UAVs (202) and the gNBs (102) may include a transmitter configured to transmit radio signals to the UEs (104), a receiver to receive radio signals from the UEs (104), and a controller/processor configured to the control the transmitter and the receiver, and processing operational data exchanged in the radio signals to provide network services to the UEs (104). The controller may also include interfaces that allow the controller to be connected to the (central) CN. The controller may be configured to orchestrate the operation of the components of the UAVs (202) and the gNBs (102) to provide telecommunication services, among others, the UEs (104). In some embodiments, the UAVs (202) and the gNBs (102) may also include components that allow operations specific to their implementation to be performed. In some examples, the UAVs (202) may include wings or propellers that allow the UAVs (202) to fly. The controller may include one or more processors, and a memory. The memory may include one or more processor-executable instructions that are executed by the one or more processors for orchestrating the components of the RAN node.

In some embodiments, both the UAVs (202) and the gNBs (102) may be indicative of RAN nodes forming the coreless RAN network. The RAN nodes may be indicative of those RATs that may be configured to operate and provide telecommunications services, among others, to the UEs (104) without being connected to the CN. In some embodiments, RAN nodes may be configured to intermittently connect with the CN based on requirements. The coreless RAN nodes may intermittently connect to the CN for including, but not limited to, offloading operational data, updating operational data in the CN after provision of services, maintenance, upgradation, procurement of data unavailable at the RAN node, provisioning of services that require connection with the CN, and the like. The RAN node may be in the “coreless mode” when it is not connected to the CN, and the RAN node may be in the “connected mode” when RAN node is connected to the CN. In some embodiments, the UAVs (202) may be in the “flight mode” (FM) when in the coreless mode/when disconnected to the CN, and may be in the “docked mode” when in the core mode/when connected to the CN, based on the implementation.

The UAVs (202) may be indicative of an example of mobile RAN nodes. In other examples, mobile RAN nodes may be implemented in any moving vehicles such as including, but not limited to, cars, trains, planes, balloons, drones, satellites, autonomous land-based or water-based vehicles, and the like. In some applications, mobile RAN nodes may be indicative of public transport vehicles that move from one location to another, while providing network connectivity to the UEs (104). The gNBs (102) may be indicative of immobile RAN nodes. The gNBs (102) may be indicative of immobile RAN nodes that may be intermittently connected to the CN, but may also be capable of operating without being connected to the CN. Unlike mobile RAN nodes, the immobile RAN nodes may be either permanently or temporarily affixed to a predetermined location.

In some embodiments, the UAVs (202) and the gNBs (102) may be configured to intermittently connect to and communicate with the CN based on requirements. In other embodiments, the UAVs (202) and the gNBs (102) may be configured to operate in a decentralized manner, without requiring connections with the CN. In such embodiments, the UAVs (202) and the gNBs (102) may be configured to exchange operational data with each other to provide the services to the UEs (104), without requiring communication with the (central) CN. Hereinafter, the UAVs (202) and the gNBs (102) may be collectively referred to as RAN nodes. In some embodiments, the RAN nodes may be configured to publish/broadcast

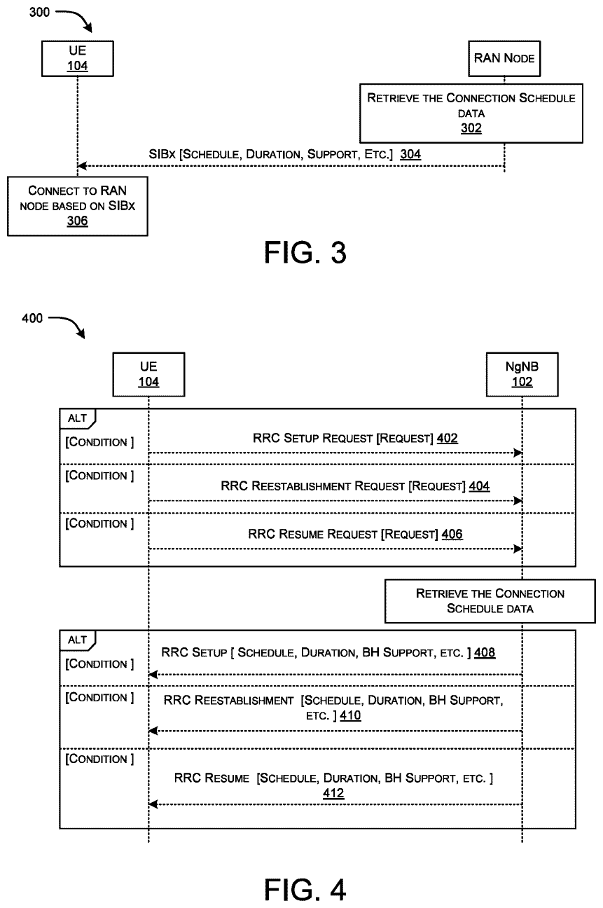

whether they are connected to the CN. In some embodiments, the UEs (104) may be configured to ascertain whether the RAN nodes are connected to the CN. The UEs (104) may then choose to connect to the RAN nodes and select the appropriate communication protocol based on whether the RAN nodes are connected to the CN. The communication protocols and data flow between the UEs (104), and the UAVs (202)/gNBs (102) may be suitably adapted based on whether the RAN nodes are connected to the CN. The means for ascertaining whether the RAN nodes are connected to the CN are described with reference to FIGS. 3 and 4.

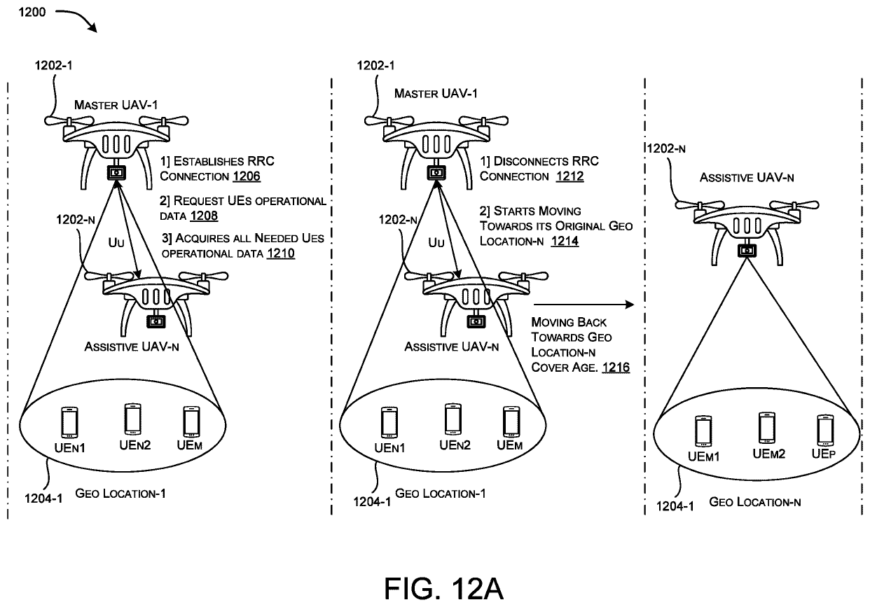

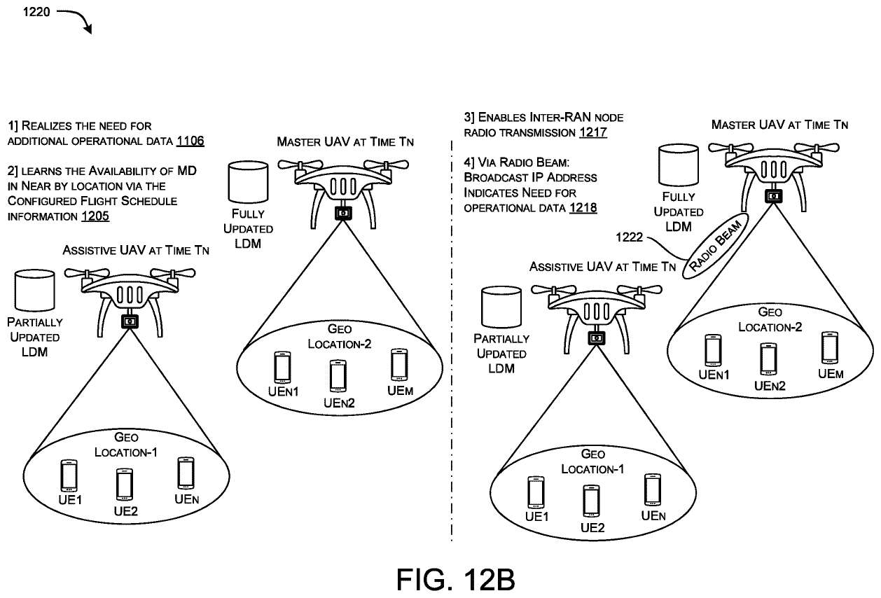

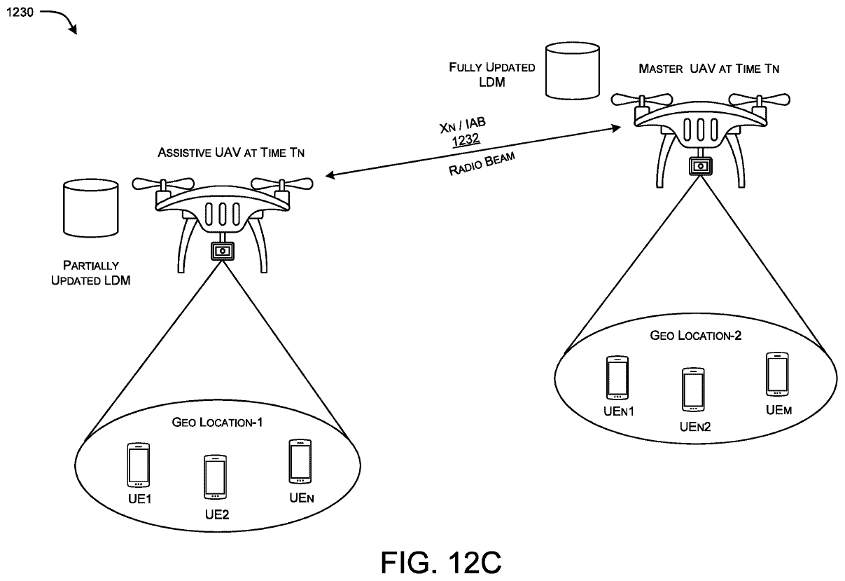

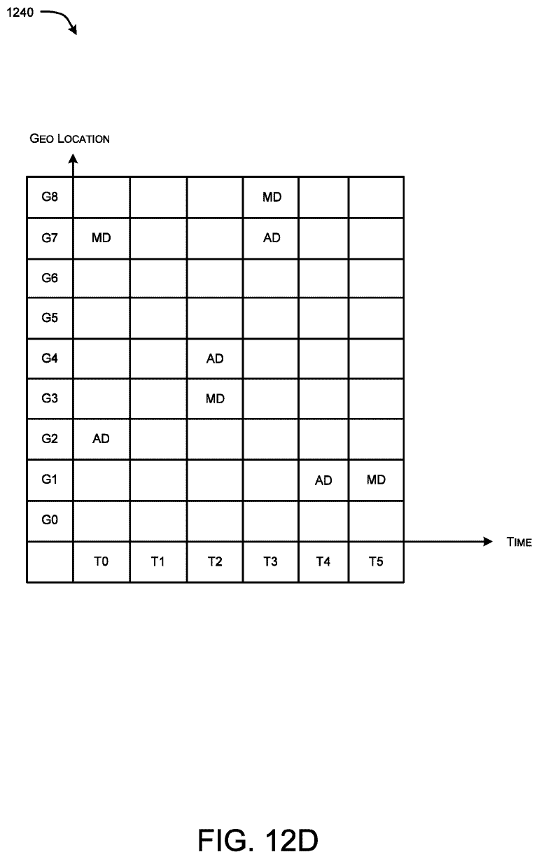

In some embodiments, the RAN node may be configured to broadcast/periodically transmit a set of dedicated signals, indicating its connection with the CN. FIG. 3 illustrates an exemplary communication (300) from the RAN node publishing indicating if it is in the connected mode or the coreless mode, in accordance with an embodiment of the present disclosure. In an embodiment, the RAN node may be configured to retrieve (302) a connection schedule data indicative of a schedule of when the RAN node connects to the CN. In such embodiments, the connection schedule data may include, but not be limited to, details on when the RAN nodes are configured to connect to the CN (i.e. time and duration for which the RAN node remains in core mode and coreless modes during any interval of time), backhaul support, accepted communication protocols, identifier attributes, and the like. In examples where the RAN node is indicative of the UAVs (202), the schedule data may include durations of time when the UAV (202) is in the FM/coreless mode, and durations of time when the UAV (202) is connected to the CN. An example connection schedule data has been provided in, and described with reference to FIG. 12D.

In some embodiments, the RAN nodes may broadcast (304) the connection schedule data through a set of dedicated signals to the one or more UEs (104). By broadcasting the connection schedule data, the RAN node may indicate to the UEs (104) communicating therewith whether the RAN node is operating in the connected or the coreless mode. Whether the RAN node is connected to the CN or not may be inferred from the connection schedule data. In some embodiments, the RAN node may be configured to periodically broadcast the set of dedicated signals. The periodicity may be predetermined, and optimized to minimize energy consumption while providing continuous telecommunication services. In other embodiments, the set of dedicated signals may include explicit indications of whether the RAN node is either in the connected mode or coreless mode.

In some embodiments, the set of dedicated signals may be transmitted either through System Information Blocks (SIBs) format or through Master Information Blocks (MIBs) format. In some embodiments, the RAN node may allocate one or more blocks in the SIBs or MIBs to indicate when the RAN node may be connected to the CN during specified interval. In other embodiments, the SIBs or MIB may be configured to carry the connection schedule data. On receiving the UEs (104) may be configured to connect (306) with the RAN node based on the SIB message. In some embodiments, the UEs (104) may determine whether the services required by the UEs (104) can be fulfilled by the RAN node based on whether it is connected to the CN.

In some embodiments, the set of dedicated signals may be transmitted using a Radio Resource Control (RRC) protocol. In an example, the RAN node may request the UE (104) to switch to a security authentication mechanism, where the RAN (102) is in the coreless mode on demand using one or more of RRC based messages. The SIBs or MIBs may be transmitted via the RRC-based messages to the UE (104). In some embodiments, the UE (104) may also be configured to query if the RAN node is operating in the coreless mode or if it is in the connected mode through one or more of the layer 2 messages of the RRC. Layer 2 messages may be signals transmitted via data link layer 2 protocols.

FIG. 4 illustrates an exemplary communication (400) from the UE (104) and associated mechanism for the UE (104) to query a RAN node if it is in a coreless or a connected mode, in accordance with an embodiment of the present disclosure. Accordingly, the disclosure provides a mechanism for the UE (104) to query a RAN node if it is in a coreless or a connected mode. In some embodiments, the UE (104) may query, by transmitting a set of request messages, the RAN node to check whether the RAN Node is or is going to be in a coreless mode. In an example, the UE (104) may transmit the set of request signals to the UAVs (202) to query if it is in the FM mode. In some embodiments, the set of request signals may be indicative of RRC messages (402), (404), and (406). As a response, the RAN node may retrieve the connection schedule data from a database thereof, and transmit the dedicated signals, such as RRC messages (408), (410), (412).

In some examples, the UE (104) may query the request by setting the flag ‘FM request’ to ‘1’ in any one of RRC SETUP REQUEST (402). RRC REESTABLISHMENT REQUEST (404), or RRC RESUME REQUEST (406) messages, but not limited thereto. The RAN node may then retrieve the connection schedule data, and respond to the query by including the connection schedule (may include one or more schedules), duration of the connection, details of the backhaul supported or not, etc., in either one of RRC SETUP (408), RRC REESTABLISHMENT (410), or RRC RESUME (412) messages, but not limited thereto.

In some embodiments, the UE (104) may be configured to receive the set of dedicated signals having the connection schedule data from the RAN node, and may be free to use this information to effectively utilize the scenario, or to switch to a different RAN node based on the specified connection duration. The set of dedicated signals may be received either due to the RAN node broadcasting said signals, or in response to the set of request signals transmitted by the UE (104). The UE (104) may establish a connection with the RAN node based on the connection data in the set of dedicated signals. In some embodiments, the UE (104) may determine whether the RAN node is connected to the CN using the connection schedule data, and determine whether the services required by the UE (104) may be provided by the RAN node.

In an example, when the UE (104) requires telecommunications services that are only provided by the CN, the UE (104) may switch to other RAN nodes that are connected to the CN at the time of receiving the dedicated signals. In other examples where the services required by the UEs (104) can be availed from the RAN node, the UE (104) may establish a connection with the RAN node. In such examples, the UE (104) may be configured to select a communication protocol for communicating with the RAN node, based on whether the RAN node is connected to the CN or not. The existing broadcast mechanism may be reused to indicate the updated information if any.

When the UEs (104) connect to the RAN nodes, regardless of whether said RAN nodes are connected to the CN, the RAN nodes may be configured to provide services to the UEs (104). Services may include, but not be limited to, telecommunication services such as voice calls, messaging, video conferencing, etc., internet connectivity, file transfer, data exchange services, and the like. In some embodiments, the RAN nodes may be configured to independently provide services to the UEs (104) without requiring connection with the CN. In such embodiments, the RAN node may include network entities that allow operational data to be stored and processed therewithin to provide the services to the UEs (104). In other embodiments, the RAN nodes may be configured to intermittently communicate with the CN, or with other RAN nodes for providing services to the UEs (104). The RAN nodes may require interaction with the CN or the other RAN nodes for performing services/operations such as, for example, authorization/authentication, call handovers, and the like, but not limited thereto. Further, in such embodiments, the RAN nodes may be configured to retrieve the operational data required for providing the services requested by the UEs (104). In some examples, the RAN nodes may require operational data, such as subscriber data, associated with the UEs (104) for determining the services and policies applicable to the UEs (104) requesting services therefrom. If the operational data required for providing the services to the UEs (104) is unavailable at the RAN nodes, said RAN node may request and retrieve the operational data from other RAN nodes or the CN. However, if the operational data, and correspondingly the services and policies applicable to the UEs (104), are available, the RAN node may retrieve the subscriber data and provide the services to the UEs (104) therewith.

In some embodiments, the operational data may include, but not be limited to, subscriber data, policy and enforcement data, authentication keys and security information, (encrypted) messages/data packets transmitted by the UEs (104), and the like. Throughout the disclosure, operational data may be indicative any data exchanged between the RAN node, and the UEs (104), other RAN nodes, and intermittently with the (central) CN for providing services to the UEs (104). While some examples describe the operational data in the context of subscriber data, it may be appreciated by those skilled in the art that the operational data may not be limited thereto.

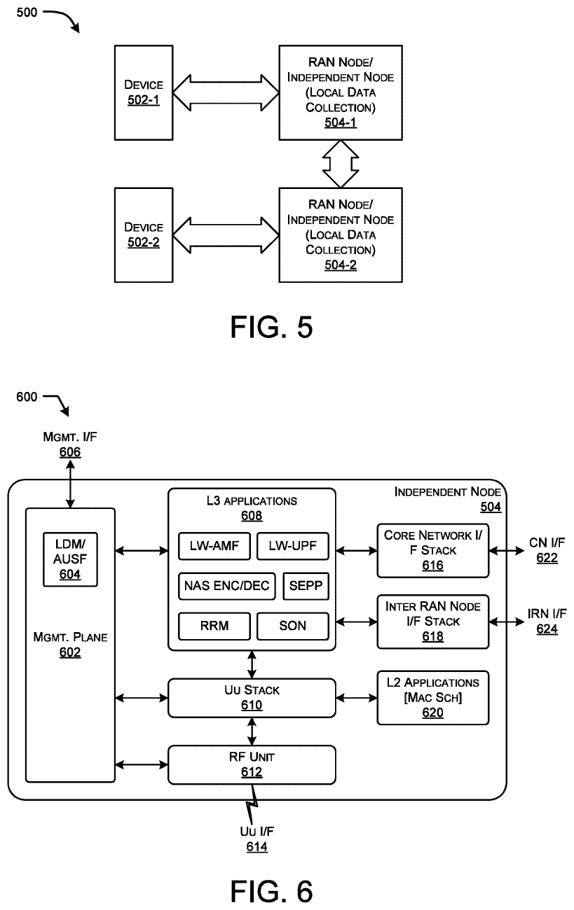

FIG. 5 illustrates an exemplary mechanism (500) of an independent RAN node that provides services to the UEs (104) independently of the CN, in accordance with an embodiment of the present disclosure. The present disclosure proposes a new RAN node definition, such as RAN node/independent RAN nodes (504-1, 504-2) (collectively referred to as independent nodes (504)) shown in FIG. 5. The independent node (504) may include one or more network entities that may support/provide a plurality of network operations/services independently of the CN. The terms independent node (504) and RAN nodes may be used interchangeably hereinafter. In some examples, the independent nodes may be configured to perform, among other services, local authentication/authorization of UEs (104) (such as devices 502-1, 502-2) independently of the CN.

In some embodiments, the RAN nodes (e.g., such as independent nodes 504-1, 504-2) may be a standalone entity that does not require to interface with the CN to provide the services to the UEs (104). Such RAN nodes may be configured to communicate with the UEs (104) using prevalent radio-related protocols. In some embodiments, such RAN nodes may also support an Internet Service Provider (ISP) interface to provide services from the internet. In some embodiments, the independent nodes (504-1, 504-2) may also include a CN interface for when such a CN becomes available. Data required for performing certain network services/operations may be stored in the independent nodes (504-1, 504-2), and may be offloaded to any one of: appropriate application servers, databases, DNs (114) or the CN, but not limited thereto. In an embodiment, the independent node (504-1) may support an inter-RAN interface to connect to other independent nodes (504-2). The independent node (504-1 and 504-2) may also support a management plane as explained below with reference to FIG. 6.

In an example embodiment, the independent nodes (504-1, 504-2) may be implemented in mobile RAN nodes, such as the UAV (202), that may provide functionalities/services provided by traditional RANs. In some embodiments, the mobile RAN nodes (such as the UAV (202)) may be configured to provide network coverage and services to a plurality of UEs (104) in a given geolocation. In some embodiments, the mobile RAN nodes may also be configured to move from one geolocation to another. While the independent nodes (504-1, 504-2) may be preferably implemented as mobile RAN nodes, it may be appreciated by those skilled in the art that the independent nodes (504-1, 504-2) may be suitably to be implemented in immobile RAN nodes.

In such embodiments, the RAN nodes may be configured to provide services to the UEs (104) in a decentralized manner. By being configured to interact with each other, the RAN nodes may be configured to exchange operational data with each other based on the requirements of the services requested by the UEs (104). In such embodiments, the operational data required for providing services, such as subscriber data required to uniquely identify UEs (104) and retrieve applicable policies, may be distributed across each of the RAN nodes. In some embodiments, the RAN nodes may maintain a partial set of the operational data in their corresponding database, and may interact with each other to retrieve the required operational data for providing services to the UEs (104) that is unavailable at the RAN nodes. In some examples, the RAN nodes may be configured to store and maintain operational data associated with the UEs (104) that typically avail services from a geolocation designated to the RAN nodes. In such examples, the RAN nodes may be configured to communicate and retrieve operational data of a new UE entering into the designated geolocation from other RAN nodes, when the operational data is unavailable therewith. By distributing the operational data across a plurality of RAN nodes, resources and cost required for manufacturing and deploying the RAN nodes may be reduced. Further, the intractability of the RAN nodes may allow them to function without requiring constant connection with the CN, thereby allowing the RAN nodes to be mobile and decentralized.

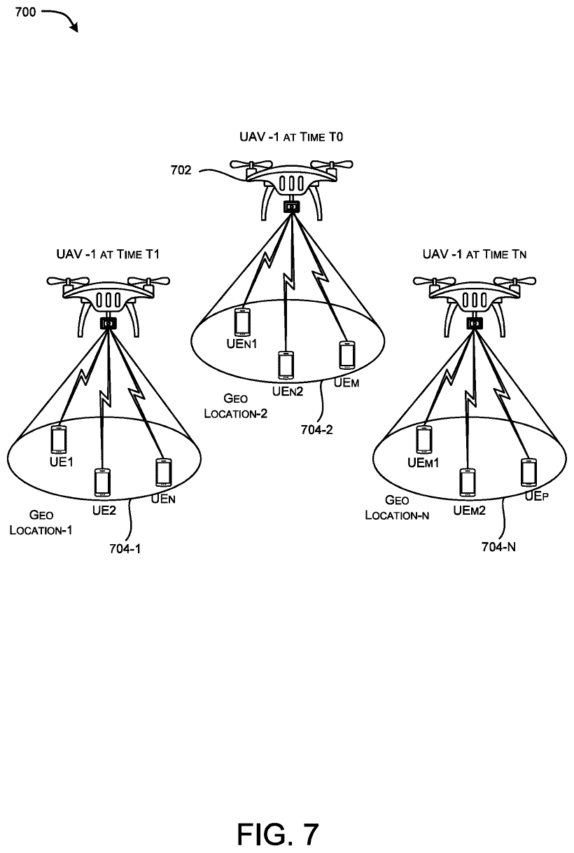

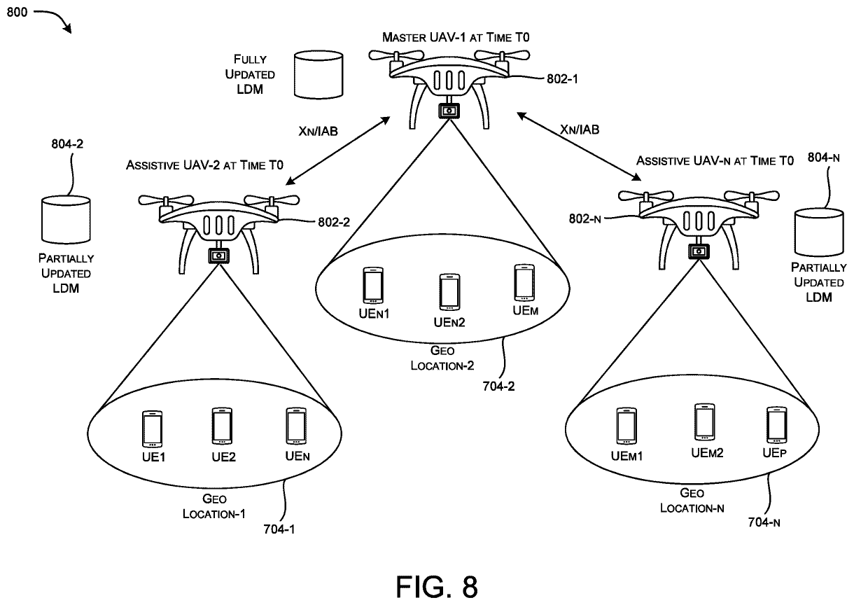

In some implementations, a fleet of mobile RAN nodes, such as a plurality of UAVs (702) as shown in FIG. 7, may be deployed at a corresponding geolocation assigned to each of the UAVs (702). The fleet of UAVs (702) may be configured to move between different geolocations based on requirements. In some examples, the fleet of UAVs (702) may be programmed to move based on demand for services. Further, the mobility of the UAVs (702) may allow them to be deployed quickly at different geolocations based on demand/network traffic, or other requirements, as described subsequently with reference to FIGS. 7 and 8.

FIG. 6 illustrates an exemplary independent node architecture (600), in accordance with an embodiment of the present disclosure. The disclosure provides an inter-RAN node communication mechanism by providing newer network entities/modules in the independent node architecture (600) as shown in FIG. 6. For example, when the RAN nodes are independent of CN, there may be situations where the RAN nodes may need to communicate with each other to assist in any operational data or call handovers between a set of serving the RAN nodes. In some embodiments, the independent node (504) may include a management plane (602) having Local Dynamic Maps (LDM/AuSF) (604) that may be updated based on the geolocation served by said independent nodes (504), and the UEs (104) connected to the RAN node. In some embodiments, the LDM (604) may be a local database having topographical, positional and status data (collectively referred to as the LDM data) of objects, such as including, but not limited to, mobile RAN nodes, immobile RAN nodes, pedestrians, obstacles, and the like, within a geographical region/geolocation. In some embodiments, the LDM (604) may be configured to maintain the information on the objects in real-time. In some embodiments, the LDM (604) may allow the RAN nodes/independent nodes (504) to navigate and coordinate with each other. The mobile RAN nodes may be configured to move using any transportation means, such as any one or combination of including, but not limited to, wheels, wings, floats, and the like, that are propelled by engines, motors, propellants, and the like.

In some embodiments, the management plane (602) may also include the AUSF configured to verify the identity of subscribers using the UEs (104). In some embodiments, the LDM data may be repurposed for authenticating UEs (104), or verify identity of other independent nodes (504). In some embodiments, the management plane (602) may be configured to exchange the LDM data via a management interface (I/F) (606).

In some embodiments, the independent node (504) may include Layer 3 (L3) Applications (608), Uu stack (610), and Radio Frequency (RF) unit (612). In some embodiments, the L3 applications (608) may include a Light Weight (LW)-AMF configured to perform network operations, such as including, but not limited to, UE (104) registration and authentication, encryption, security, interworking between the network entities, session management, mobility management, policy enforcement, and the like. The LW-AMF may also be configured to determine if the independent node (504) is connected to the CN. The L3 applications (608) may further include an LW-UPF configured to connect and allow exchange of data packets with a Data Network (DN), such as the Internet. The LW-AMF and the LW-UPF may be adapted to be light weight in terms of hardware and energy consumption, thereby allowing mobile RAN nodes, such as UAVs (202) to operate while being in transit or in FM.

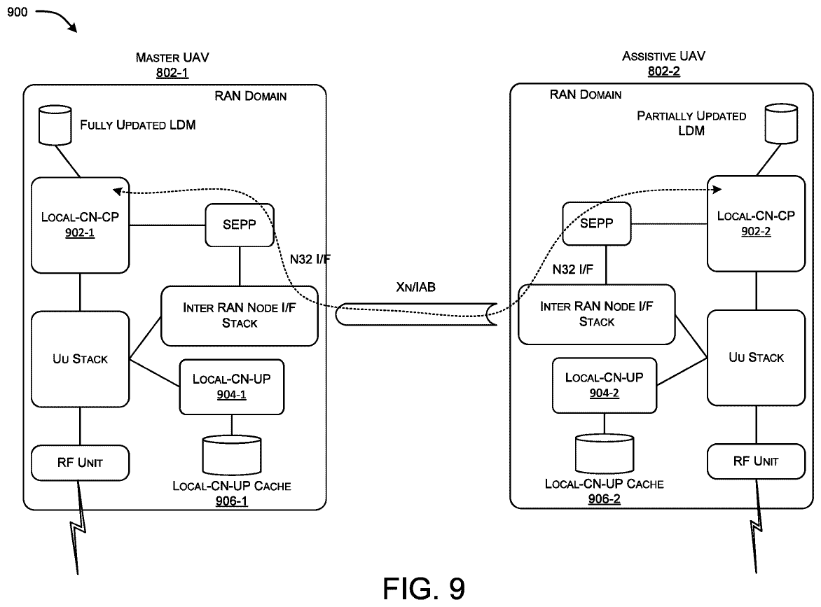

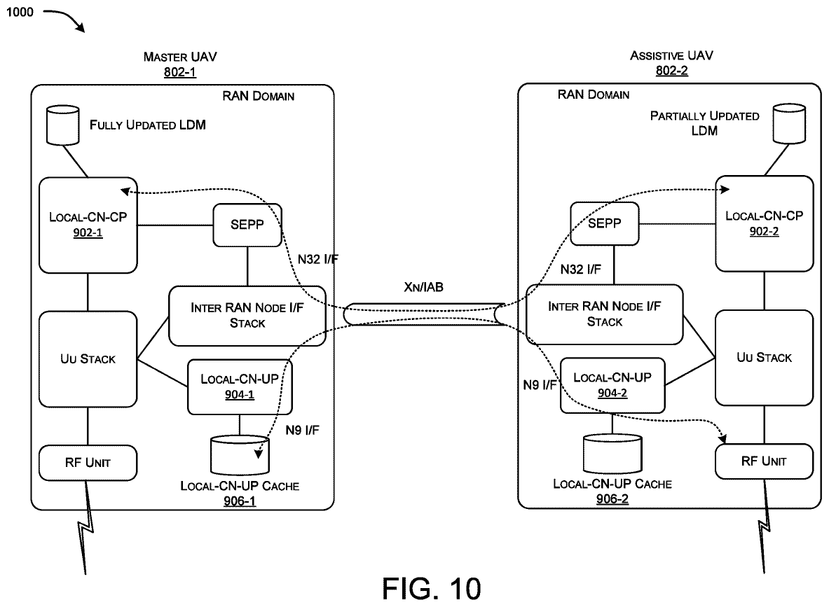

The L3 applications (608) may also include a Radio Resource Management (RRM) entity configured to transmit and receive messages using RRC. The RRM entity may be configured to allow for exchange messages with entities such as the UEs (104), the CN, or other RAN nodes. In some embodiments, the L3 application (608) may further include a Self-organising Network (SON) configured to perform any one or combination of including, but not limited to, planning, configuring, managing, optimizing, and healing, among others, for the RAN nodes. In some embodiments, the L3 application (608) may also include a Non-Access Stratum (NAS) entity configured to encrypt and decrypt data packets transmitted from the L3 application (608). The aforementioned entities may allow the RAN nodes to securely receive, process, and perform network operations using operational data to provide services to the UEs (104). In some embodiments, the L3 application may include a Security Edge Protection Proxy (SEPP). The functions of the SEPP are described subsequently with reference to FIGS. 9 and 10. In some embodiments, the L3 applications (608) may be indicative of a local CN control plane (CP), such as the local CN CP (902-1, 902-2) shown in FIGS. 9 and 10. The L3 application (608) may be configured to perform the functions of control plane of the (central) CN.

In some embodiments, the Uu stack (610) may be configured to control the RF unit (612) to communicate with the UEs (104). The Uu stack (610) may be indicative of an air interface or a physical layer stack. In some embodiments, the Uu stack (610) may use communication protocols and interfaces that allow data packets/signals to be exchanged between two entities that are configured to handle such data packets/signals in different formats/channels/medium. The Uu stack (610) may enable the RAN nodes to communicate with the UEs (104), and also other RAN nodes and the (central) CN using corresponding interfaces. The Uu stack (610) may also include a corresponding Uu I/F (614).

In some embodiments, the independent node (504) may also include Core Network Interface (I/F) stack (616), a Inter RAN Node I/F Stack (618), and Layer 2 (L2) Applications (MAC Schedulers) (620). In some embodiments, the Core Network (CN) I/F (622) may be configured to allow communication with the CN, when connected therewith. In examples where the independent node (504) is a mobile RAN node such as the UAV (202), the CN I/F (622) may be configured to connect with the CN in the docked mode. In some embodiments, the CN I/F (622) may be configured to a local CN cache indicative of a cache/database storing a copy, either full or partial, of the CN. The local CN cache may store and allow the RAN node to utilize the operational data therein to provide services to the UEs (104). In some embodiments. the Inter RAN Node I/F (624) may be configured to allow communication with other RAN nodes/independent nodes (504). The inter RAN node I/F (624) may enable two or more RAN nodes to exchange the operational data required to provide services to the UEs (104).

In some embodiments, the Uu I/F (614), the inter RAN node I/F (624), and the CN I/F (622) may be any one of wired or wireless communication interface, and may be configured to allow data packets to be transmitted therethrough as a set of signals. The set of signals may include signals in form factors including, but not limited to, electric signals, digital signals, radio signals, analog signals, light signals, and the like. The RAN node/independent node (504) may be configured to retrieve and/or offload the operational data from the CN or other RAN nodes using the CN I/F (622) or the inter RAN node I/F (624), respectively. for providing services to the UEs (104). In some embodiments, the Uu stack (610) may be connected with the CN I/F (622) or the inter RAN node I/F (624), and may be configured to control the flow of data packets/signals therethrough.

In some embodiments, the L2 applications (620) may include a MAC scheduler that is configured to allocate radio resources for enabling communication between the independent node (504), and other entities such as UEs (104), other RAN nodes, and the CN. In some embodiments, the MAC schedule may be configured to assign time and frequency slots to the other entities. The L2 application (620) may be indicative of local CN user plane (UP), such as local CN UP (904-1, 904-2) shown in FIGS. 9 and 10. The L2 application (620) may be configured to perform functions of user plane of the CN. The L2 application (620)/the local CN UP (904), and the L3 application (608)/local CN CP (902) may belong to a local CN of the RAN node. The local CN may be configured to provide the functions of the central CN without requiring active connection therewith. As described above, the local CN may include one or more network entities, corresponding to the network entities of the central CN, adapted to perform network operations/services.

While FIG. 6 shows the independent node (504), and specifically the L3 application (608) and the L2 application (620), having a few network entities, it may be appreciated with those skilled in the art that the independent node (504) may include other entities that have not been shown for the purposes of clarity. Further, each of the network entities may be implemented using any one or combination of including. but not limited to, processors, electrical circuits, microcontrollers, digital signal processors, and the like, that are configured to execute one or more processor executable instructions to perform a predetermined function.

The aforementioned components may allow the independent node (504) to interact with other independent nodes (504), or the CN, to exchange data and provide services to the UEs (104). FIGS. 7 and 8 illustrates some exemplary scenarios requiring the independent nodes (504) to interact with each other.

FIG. 7 illustrates an exemplary scenario (700) of a mobile RAN node, such as UAV (702), at various time instances at different geo locations, in accordance with an embodiment of the present disclosure. As shown, the UAV-1 (702) is configured to provide network coverage and services to a first set of UEs (UE1, UE2, UEN) at a geolocation-1 (704-1) at time T1, to a second set of UEs (UEN1, UEN2, UEM) at a geolocation-2 (704-2) at time T2, and to a third set of UEs (UEM1, UEM2, UEP) at a geolocation-N (704-N) at time TN, respectively. As described herein, the UAV-1 (702) may be scheduled/configured to fly to various locations to provide network coverages and services at different geolocations at different time instants. The flight of the UAV through the geolocations (704-1, 704-2, . . . 704-N) at each of the times T1, T2, . . . TN, may be determined based on expected network traffic (i.e. the number of UEs (104) requesting services from the RAN nodes) at said geolocations and time. In an example, the geolocations 1 (704-1) may be indicative of a residential area where the network traffic may be higher at time T1 (such as morning), geolocation 2 (704-2) may be indicative of a workplace where the network traffic may be higher during at time T2 (such as during the day), and geolocation N (704-N) may be indicative of a recreational location (such as bars and restaurants) at time TN (such as in the evening). In an operation mode, the mobile RAN node or the UAV-1 (702) may serve a set of users at the geolocation (704-1, 704-2, . . . 704-N). In some embodiments, as the geolocation changes. the user base may also change. To support such situations and scenarios, a plurality of interconnected UAVs-1 (702)/mobile RAN nodes indicative of the independent node (504) should have the information of the complete subscriber base.

In some embodiments, a plurality of interconnected RAN nodes/independent nodes (504) may be configured to exchange information/operational data therebetween to provide services to the UEs (104). In some embodiments, the plurality of RAN nodes, such as the independent nodes (504), may be configured to have a master-assistant paradigm. FIG. 8 illustrates an example scenario (800) of a master RAN node and two assistive RAN nodes catering to different geolocations at the same time instant, in accordance with an embodiment of the present disclosure. As shown, the RAN nodes may be implemented as UAVs (802-1, 802-2, . . . 802-N) (collectively referred to as UAVs 802). In some embodiments, there may be one or more UAVs (802) that work in tandem where one UAV may be a master UAV with a full set of user subscription information (such as those having fully loaded LDM), and other assistive UAVs that may configured to connect to the master UAV for user subscription information verification. As described herein, the different UAVs (master and assistant/slave) may connect with each other via the inter RAN node I/F (624).

In some examples, the inter RAN node I/F (624) may be indicative of an enhanced Xn interface. Further, in other examples, the UAVs may be configured to connect over any transport mechanism, including via an Integrated Access Backhaul (IAB) link (1232) as shown in FIG. 12C, or any proprietary wireless link or a satellite link, but not limited thereto. While the example scenario (800) has been described in the context of mobile RAN nodes, such as UAVs (802), being configured to exchange subscriber information and/or LDM (804-1, 804-2, . . . 804-N) using the master-assistant paradigm, it may be appreciated by those skilled in the art that the RAN nodes may be implemented as any mobile or immobile RAN node, and said RAN nodes may be configured to exchange any operational data required for providing services to the UEs (104).

As shown in FIG. 8, a master UAV-1 (802-1) provides network coverage and services to a set of UEs (UEN1, UEN2, UEM) at the second geolocation-2 (704-2) at time T0. A first assistive UAV-2 (802-2) provides network coverage and services to the set of UEs (UE1, UE2, UEN) at the first geolocation-1 (704-1) at time T0. Similarly. a second assistive UAV-N (802-N) provides network coverage and services to the set of UEs (UEM1, UEM2, UEP) at the third geolocation-N (704-N) at time T0. The master UAV-1 (802-1) functioning as an independent node (504) may include a fully updated LDM (804-1). The first and second assistive UAVs (802-2 and 802-N) may include partially updated LDMs (804-2 and 804-N) respectively. Further, each of the UAVs (802-1, 802-2, 802-N) may communicate with each other for any information exchange, such as for subscriber data or any other operational data, using the Xn interface via IAB link (1232).

FIGS. 9 and 10 illustrate exemplary scenarios (900) and (1000) for exchange of operational data between the master RAN node and the assistive RAN nodes via an enhanced Xn interface/inter RAN node I/F (624), in accordance with an embodiment of the present disclosure. In some embodiments, a new entity in L3 Applications (608) referred to as SEPP is proposed in the disclosed independent node architecture (e.g., 600) to enable inter mobile RAN node communication. In some embodiments, the SEPP may be a non-transparent proxy and may support a set of functionalities that include, but not limited to, message filtering and policing, and the like, using the local CN CP (902-1, 902-2). Further, the SEPP may be configured to protect the connection between the RAN nodes from a security perspective, i.e., the SEPP by preventing duplicate service authorization applied by the master or the assistive UAVs (802-1 and 802-2)/RAN nodes. Further, the SEPP may hide the topology data of the RAN nodes for security reasons. In some embodiments, the SEPP may be implemented as a functionality between RAN nodes (master UAV 802-1 and assistive UAV 802-2). The SEPP may provide for secure inter RAN node communications seamlessly via the Xn interface/IAB link (1232). In some embodiments, the SEPP may also validate the (identity of) other RAN nodes and also ensure that any form of attack, such as including, but not limited thereto, a denial-of-service attack. can be identified and mitigated using appropriate further action.

In an embodiment, the local CN CPs (902-1, 902-2) may be connected by the Xn interface/inter RAN node I/F (624) to exchange the operational data, such as user subscription information, between the mobile RAN nodes (i.e., master UAV 802-1 and the assistive UAV 802-2). It may be noted that there is no data exchange between the RAN nodes. All operational data pertinent to the UEs (104) requesting services from the RAN nodes may be cached at that RAN node as depicted in the FIGS. 9 and 10. In some embodiments, the operational data, such as the user subscription information/subscription data, may be exchanged between the Local CN CPs (902-1, 902-2) of the master UAV (802-1) and assistive UAV (802-2) respectively as shown in FIG. 9. In some embodiments, the operational data may be exchanged between local CN UP (904-1, 904-2), and local CN UP caches (906-1, 906-2) thereof, of the master UAV (802-1) and the Local CN CPs (902-1, 902-2) of the assistive UAV (802-2). In some embodiments, the operational data may be exchanged between the local CN UP cache (906-1) and the RF unit of the assistive node (802-2), as shown in FIG. 10. In some embodiments, the Local CN CPs (902-1, 902-2) and the local CN UP (904-1, 904-2) of the master and assistive nodes (802-1, 802-2) may be defined over the new enhanced Xn interface/IAB link (1232) to exchange the operational data, such as the user subscription information and the data information. In some embodiments, the operation data may be exchanged over the new enhanced N9 interface or N32 interface, as shown in FIG. 10.

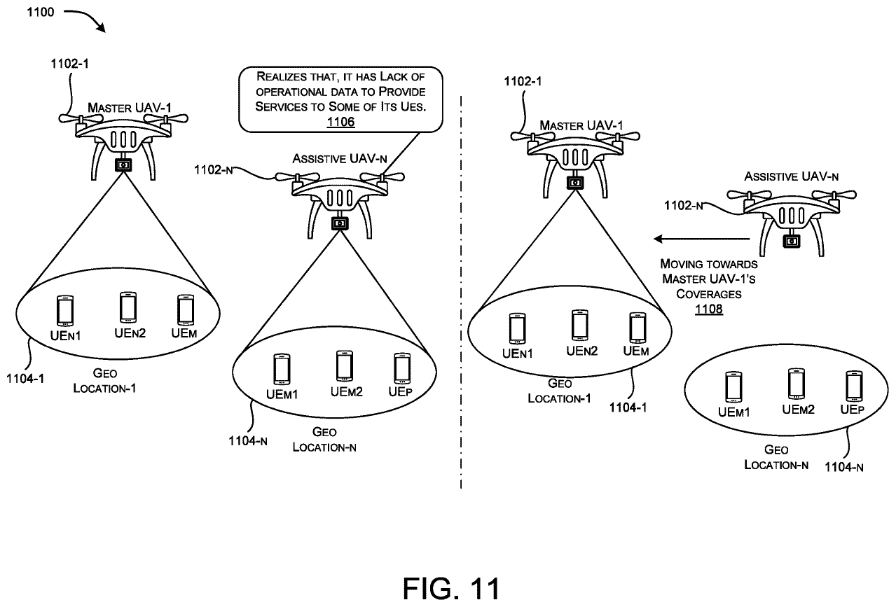

FIG. 11 illustrates an exemplary scenario (1100) in which an assistive UAV moves towards master UAV's coverage due to lack of operational data to provide services to some of its users, in accordance with an embodiment of the present disclosure. As shown, a master UAV-1 (1102-1) provides network coverage to a first set of UEs (viz. UEN1, UEN2, and UEM) at a first geolocation-1 (1104-1), and an assistive UAV-N (1102-N) provides network coverage to a second set of UEs (viz. UEM1, UEM2, and UEP) at a second geolocation-N (1104-N). In an embodiment, at step (1106) of the method executed by the assistive UAV-N (1102-N) for aligning towards the master UAV-1's coverage, the assistive UAV-N (1102-N) determines that it has lack of operational data, such as of the user subscription data, for providing services to some of its UEs (or users of UEs) from the second set of UEs. In such embodiments, the assistive UAV-N (1102-N) may be configured to communicate with the master UAV-1 (1102-1) for obtaining information about the master UAV-1's network coverage and the first geolocation (1104-1). In some embodiments, in response to a query from the assistive UAV-N (1102-N), the master UAV-1 (1102-1) may send the location details and the network coverage information. In some embodiments, at step (1108), the assistive UAV-N (1102-N), based on the received information, may stop providing its services and moves towards the master UAV-1's network coverage area or the first geolocation.

FIG. 12A illustrates an exemplary set of steps (1200) executed by master UAV and assistive UAV when the assistive UAV moves towards a geolocation coverage of the master UAV, in accordance with an embodiment of the present disclosure. As shown, a master UAV-1 (1202-1) may communicate with an assistive UAV-N (1202-N) over a Universal Mobile Telecommunications System (UMTS) air interface or the Uu I/F (614), and may also provide network coverage to a first set of UEs at a first geolocation-1 (1204-1). At step (1206), the assistive UAV-N (1202-N) establishes RRC connection with the master UAV-1 (1202-1). In some embodiments, at step (1208), the assistive UAV-N (1202-N) requests the operational data, such as the user subscription data, from the master UAV-1 (1202-1) using the established RRC connection. In some embodiments, in response to a query from the assistive UAV-N (1202-N), the master UAV-1 (1202-1) may send the requested information/operational data. At step (1210), the assistive UAV-N (1202-N) may acquire all the operational data required for providing services to the UEs (104), such as the user subscription data, from the master UAV-1 (1202-1). At step (1212), the assistive UAV-N (1202-N) may disconnect the RRC connection established at step (1206) and, at step (1214), may start moving towards its original geolocation-N (1204-N) as shown in the FIG. 12A. The flight from the current location to the geolocation-N (1204-N) is indicated as (1216) in FIG. 12A.

FIGS. 12B and 12C illustrate scenarios (1220, 1230) where assistive UAV decides to connect with master UAV, in accordance with an embodiment of the present disclosure. Since operational data associated with the UEs (104) may be required to provide services thereto, the assistive UAV, one receiving a request for services from UEs (104) may determine if the operation data is available within its network entities, such as the local CN UP cache (906) or the LDM (604). When the operational data is unavailable within the UAV, it may be required to retrieve the operational data from other UAVs, such as the master UAV. In some embodiments, when the assistive UAV determines a need for retrieving the operational data from the master UAV at step (1106), the assistive UAV may sniff or determine whether any master UAV is in proximity to its geolocations. At step (1205), when the assistive UAV learns/determines availability of the master UAV near its geolocation, the assistive UAV may radiate/transmit a directed radio beam (1222) towards the master UAV to request the operational data at step (1218). In such embodiments, the master UAV may be configured to establish connection between the inter-RAN node I/Fs of the assistive UAV and the master UAV for transmitting the radio beam (1222) at step (1217). In some embodiments, Inter-RAN node radio interface may correspond to X2/Xn/IAB interface (1232), as shown in scenario (1230) of FIG. 12C. In some embodiments, the assistive UAV may broadcast its Internet Protocol (IP) address, and a flag indicating the need for the operational data in the radio beam (1222).

In some embodiments, the RAN nodes, such as the UAVs of FIGS. 11 and 12, may be configured to either move or transmit based on the geolocation of the master RAN node. In some embodiments, the (assistive) RAN node may transmit the radio beam (1222) if the master RAN node is within a threshold distance from the (assistive) RAN node. In other embodiments, the (assistive) RAN node may move towards the master RAN node when it is beyond the threshold distance away from the (assistive) RAN node. In some embodiments, the RAN nodes may use the LDM data stored therein to make the aforementioned determination. In some embodiments, the LDM data may also include the connection schedule data of the master RAN node, as well as other RAN nodes.

FIG. 12D illustrates an exemplary flight schedule (1240) configured for all master and assistive UAVs in a particular geographic location, in accordance with an embodiment of the present disclosure. In some embodiments, the master UAV, when in the flying mode, may initiate the Inter-RAN node radio transmission, for example, using Wi-Fi transmission. The master UAV learns the availability of the assistive RAN nodes, such as assistive UAVs, in the nearby or adjacent geographic location, from the UAV schedule details that have been configured before the flight mode, and vice-versa. As shown in the figure, the flight schedule may be represented as a 2-D matrix. In some examples, the X-axis indicates “time” and the Y-axis indicates “geo location” for the master drones and the assistive drone. In some examples, assistive UAVs (A-UAV) and master UAVs (M-UAV) may be scheduled to fly in geo location “G1” at time “T4” and “T5” respectively. In some examples, A-UAV and M-UAV may be scheduled to fly in geo location “G7” at time “T3” and “T0” respectively. In such examples, at time duration “T0”, the M-UAV may be serving in “G7” location and A-UAV may be serving at “G2”. Since locations “G7” and “G2” are quite far. the M-UAV may continue operating without connecting the A-UAV. In this scenario, the AD at “G2”, when it realizes the need for additional subscription data, it moves towards the MD at “G7” and acquires the needed subscription data via the Uu interface (614) as described with reference to FIGS. 7, 8, 11, and 12A-12D.

At time duration T2, the M-UAV may be serving in “G3” location and A-UAV may be serving at “G4” location, which are nearby locations. In such examples, when the A-UAV at “G4” location realizes the need for additional subscription data, A-UAV initiates the inter-RAN node radio transmission, directing the transmission or radio beams towards “G3” location, and broadcast its IP address along with indications of the need of the subscription data, through appropriate SIB. A-UAV may adjust its position in such a way that, its transmission is reachable to the M-UAV. The M-UAV in T2 duration, when it learns from the configured flight schedule, that there is a nearby A-UAV, it enables the Inter-RAN node radio sniffing mode. In this mode, if the M-UAV receives any broadcast data from the A-UAV and if there is any indication of the need for subscription data. The M-UAV it may read the IP address of the A-UAV, and may initiate the establishment of the X2/Xn interface between the two RAN nodes (M-UAV and A-UAV). The M-UAV may send the X2/Xn setup request which carries its IP address to the A-UAV. The A-UAV responds with the X2/Xn setup response message, which carries the list of UEs, for which the subscription data is requested. The M-UAV collects all the requested UE subscription data and responds back to the A-UAV via X2/Xn Information transfer message which carries the list of UE subscription data. After successfully acquiring of the needed subscription data by the A-UAV, the A-UAV may initiate the release of the X2/Xn connection with the M-UAV, and continues to serve its geographic location for all its users. In examples where the A-UAV moved to be in proximity with the M-UAV, the A-UAV may return to its original location.

At time duration T3, the M-UAV may be serving in G8 location and A-UAV is serving at G7, which are nearby or adjacent locations. Hence. in such examples, the procedure is same as explained above for the time duration T2. In such examples, A-UAV may direct its inter-RAN node radio beam (1222) towards the G8 location. In the time duration T4, A-UAV is serving in the G1 geo location. Since at T4, no M-UAV is serving in any of the geo locations, the A-UAV may be alone and if A-UAV requires additional subscription information, it will be helpless and it cannot provide any service for those users.

In the time duration T5, the M-UAV may alone serve in the G1 geo location and may be fully equipped to serve its geo location. While the example discussed in FIG. 12D the flight schedule is stored in a data structure indicative of a 2D matrix, it may be appreciated by those skilled in the art that the flight schedule may be stored using any other data structure suitable to represent the flight schedules of a plurality of mobile RAN nodes.

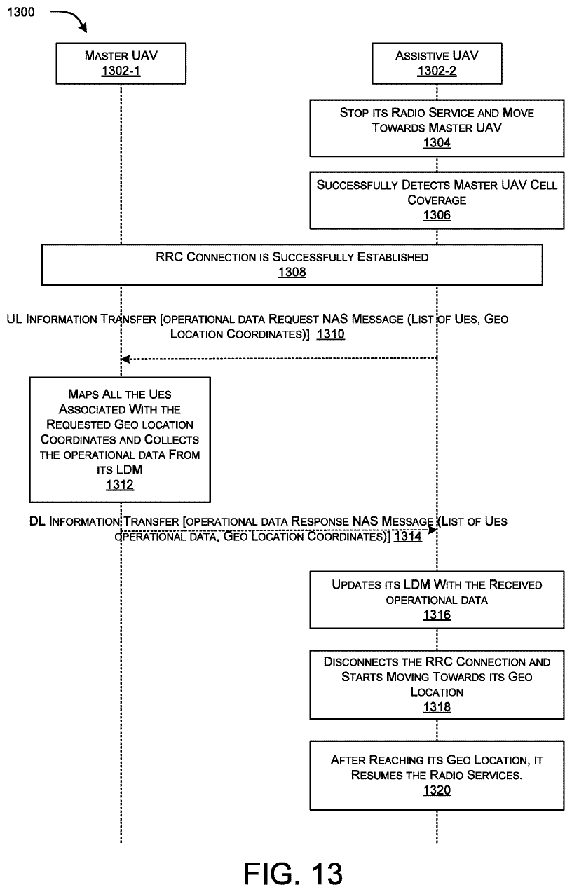

FIG. 13 illustrates an exemplary method (1300) for providing network coverage and services by a RAN node, such as an assistive UAV, for a requested geolocation, in accordance with an embodiment of the present disclosure. In an embodiment, an assistive UAV (1302-2) may have flight information of other UAVs (not shown) that form a fleet of UAVs. The flight information on other UAVs may be include, but not limited to flight schedule, IP address, geolocation, unique identifier attributes, and the like. In some embodiments, the flight information may be provided to the assistive UAV (1302-2) or a master UAV (1302-1) via an Operation. Administration, and Management (OAM) interface, or the same may be loaded into a given UAV via the management interface. In some embodiments, the fleet information i.e., the information of the other UAVs/mobile RAN nodes may be provided to the UAV (1302-2) “dynamically” over an OAM/management interface.

In an exemplary embodiment, an assistive UAV (1302-2) may sniff the other UAVs in the vicinity (not shown in FIG. 13) to confirm if the UAVs in a fleet are indeed available within its radio inter RAN link coverage range. The assistive UAV (1302-2), and generally the RAN nodes, may be configured to sniff the other UAVs by determining position of the master UAV (1302-1) in the flight schedule, or broadcasting for radio signals over a geolocation and listening to responses therefor. In other embodiments, the assistive UAV (1302-2) may be configured to use a radar to locate nearby master UAV (1302-1). In some examples, at step (1304), the assistive UAV (1302-2) stops its radio services and moves towards master UAV (1302-1). The assistive UAV (1302-2) may be configured to stop its services to the UEs (104) for either retrieving the operational data required for serving the UEs (104), maintenance, upgradation of the software, etc. At step (1306), the assistive UAV (1302-2) successfully detects the master UAV's (1302-1) cell coverage. In some embodiments, the assistive UAV (1302-2) may move from a first geolocation where it was serving the UEs (104), to a second geolocation where the master UAV (1302-1) is serving. At step (1308), the assistive UAV (1302-2) successfully establishes a communication channel, such as an RRC connection, with the master UAV (1302-1). At step (1310), the assistive UAV (1302-2) transmits a set of request signals, such as a NAS message i.e., a UL Information transfer request for user subscription data to the master UAV (1302-1), over the established RRC connection. The user subscription information may include list of UEs, geolocation coordinates, and other details as may be pre-specified.

At step (1312), the master UAV (1302-1) maps all the UEs associated with the requested geolocation coordinates and collects the required operational data, such as the subscription data, from its LDM. At step (1314), the master UAV (1302-1) transmits a set of response signals, such as through a NAS message, i.e., DL information transfer response containing the user subscription information/data requested at step (1310) to the assistive UAV (1302-2). The assistive UAV (1302-2) may receive the set of response signals. At step (1316), the assistive UAV (1302-2) updates its LDM with the received operational data, which may be used to provide services to the UEs. At step (1318), the assistive UAV (1302-2) disconnects the RRC connection established at step (1308) and starts moving towards the first geolocation (e.g., geolocation-N). At step (1320), the assistive UAV (1302-2) resumes its radio services after reaching the first geolocation.

In an embodiment, the assistive UAV (1302-2) stops its radio interface/services and uses the same radio resources to sniff the availability of other UAVs in the vicinity by reading the pilots and sync channels of other UA Vs/Mobile Radio units/RAN nodes. In an embodiment, if a given assistive UAV (1302-2) has additional radio resources to sniff other UAVs in the vicinity, then the assistive UAV does not have to stop its radio interface/services for the UEs (user devices).

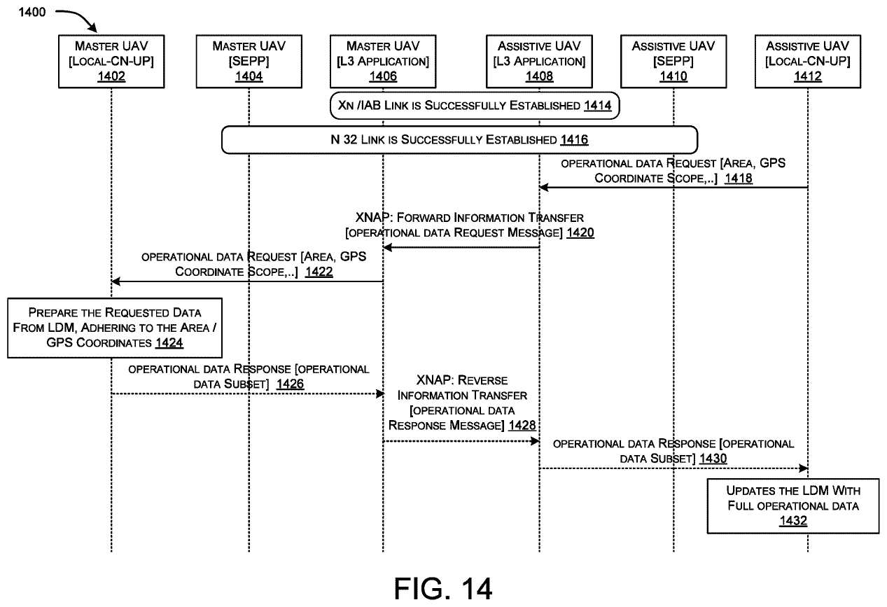

FIG. 14 illustrates a signal flow diagram (1400) that includes exemplary communication between various modules/components of master UAV and assistive UAV respectively for obtaining subscription, in accordance with an embodiment of the present disclosure. As shown, in an embodiment, the master UAV includes Local-CN-UP (1402), SEPP (1404), and L3 Application (1406). Similarly, the assistive UAV includes L3 Application (1408), SEPP (1410) and Local-CN-UP (1412). The method for obtaining the operational data, such as subscription data, may be explained with reference to the components/modules of the master UAV and the assistive UAV as shown in FIG. 14.

At step (1414), the Xn/IAB link (1232) may established between the master UAV and the assistive UAV by executing the L3 Application (1406) and the L3 Application (1408) respectively. At step (1416), N32 link is successfully established between the master UAV and the assistive UAV by executing the SEPP (1404) and the SEPP (1410). Next, at step (1418), the Local-CN (1412) sends operational data request to the L3 Application (1408). The operational data request, in an embodiment, may include, area, GPS coordinates, scope of services, etc. At step (1420), the operational data request message may be forwarded as an information transfer request using Xn Application Protocol (XnAP) to the L3 Application (1406). At step (1422), the L3 Application (1406) sends the operational data request to the Local-CN (1402). In response, at step (1424) the Local-CN (1402) prepares the requested data from local LDM (of the master UAV) adhering to area/GPS coordinates. At step (1426), the Local-CN (1402) sends an operational data response i.e., a subscription data subset, for example, to the L3 Application (1406). At step (1428), the L3 Application (1406) sends reverse information transfer i.e., operational data response message using the XnAP interface to the L3 Application (1408). At step (1430), the L3 Application (1408) sends the operational response i.e., subscription data subset, for example, to the Local-CN (1412). At step (1432), the local-CN-UP (1412) of the assistive node may be configured to update the LDM (604) associated therewith with the operational data received by the assistive node via the operational data response message.

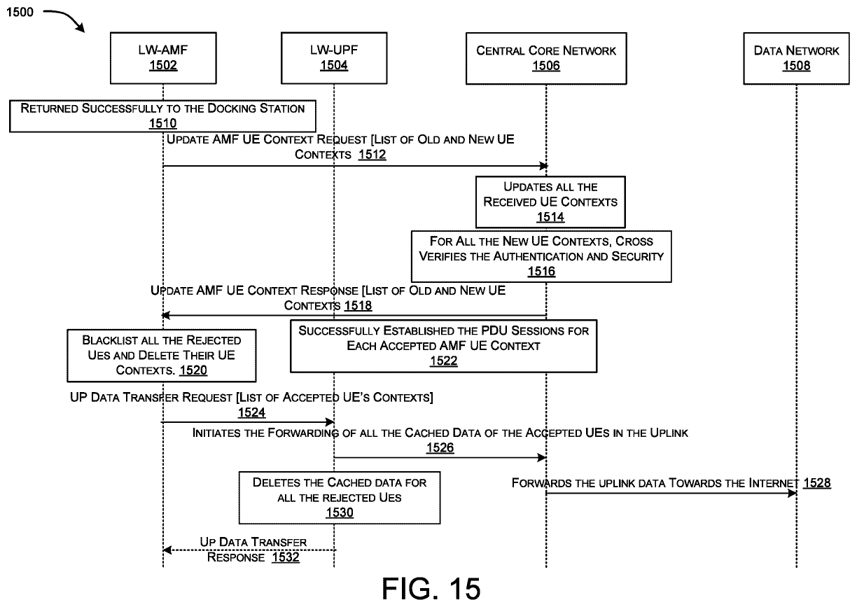

FIG. 15 illustrates a signal flow diagram (1500) for an exemplary docking procedure for UAV or a mobile RAN node to offload data once a core network or an ISP becomes available using proposed new N32/N9 messages, in accordance with an embodiment of the present disclosure. In one embodiment, a docking procedure is defined wherein the UAV or mobile RAN node will offload the data once a core network or an ISP becomes available. The disclosure proposes additional new N32/N9 messages that will help the RAN nodes to connect to the available ISP or the core network. The UAV (master UAV or assistive UAV) to be docked includes LW-AMF (1502) and the LW-UPF (1504) that communicate with central core network (1506) and data network (1508). The method for docking (or offloading of data upon availability of a core network or ISP) will be explained with reference to the above components/modules of the UAV as shown in FIG. 15.

At step (1510), the UAV successfully returns to the docking station and the LW-AMF (1502) determines the “docked” status of the UAV. In response to the docking, at step (1512), the LW-AMF (1502) transmit a set of update signals for updating AMF UE context to the central core network (1506). In an embodiment, the update signals include a list of old and new UE contexts. At step (1514), the central core network (1506) updates centralized database with the received UE contexts. At step (1516), the central core network (1506) cross verifies authentication and security for all the new UE contexts. At step (1518), the central core network (1506) transmits a set of verification signals having a set of UEs (104) that were verified by the central core network (1506). The LW-AMF (1502) may be configured to receive the set of verification signals for updating AMF UE context to the LW-AMF (1502). At step (1520), the LW-AMF (1502) may blacklist all the rejected UEs and deletes the corresponding UE contexts. At step (1522), the central core network (1506) establishes a session, such as a Protocol Data Unit (PDU) session, for each verified AMF UE context. The session may be indicative of a communication channel. At step (1524), LW-AMF (1502) may transmit uplink data transfer request to the LW-UPF (1504). In an embodiment, the uplink data transfer request includes list of accepted UE's contexts. The uplink data transfer request may be used to cause the LW-UPF (1504) to transmit the operational data cached in the local-CN-UP cache (906) to the CN (1506). At step (1526), the LW-UPF (1504) initiates transmission of cached operational data of the accepted UEs in the uplink to the central core network (1506). At step (1528), the central core network (1506) forwards the uplink data to the data network (1508) to push the data towards the internet. The RAN node may trigger the CN (1506) to forward the cached operational data to the DN (1508) by providing instructions to that effect in the uplink data transfer request. At step (1530), the LW-UPF (1504) may delete the cached operational data for all the rejected UEs (104). At step (1532), the LW-UPF (1504) uplink data transfer response to the LW-AMF (1502).

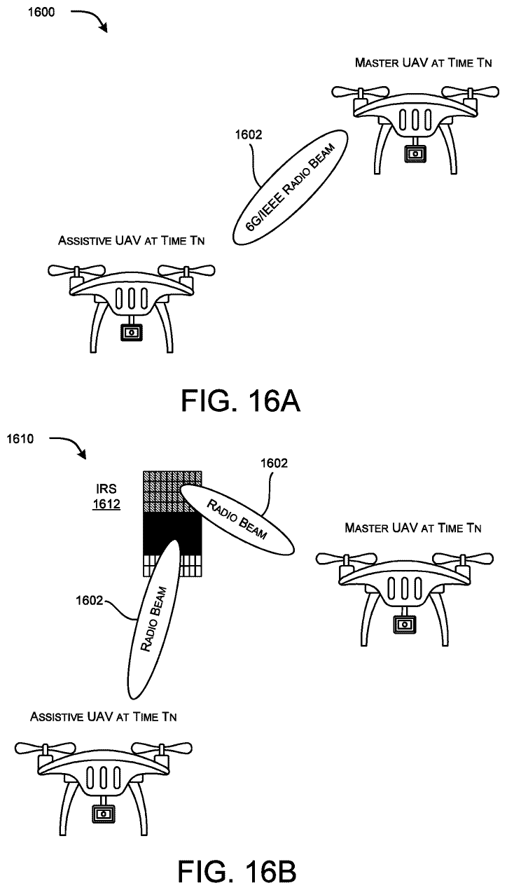

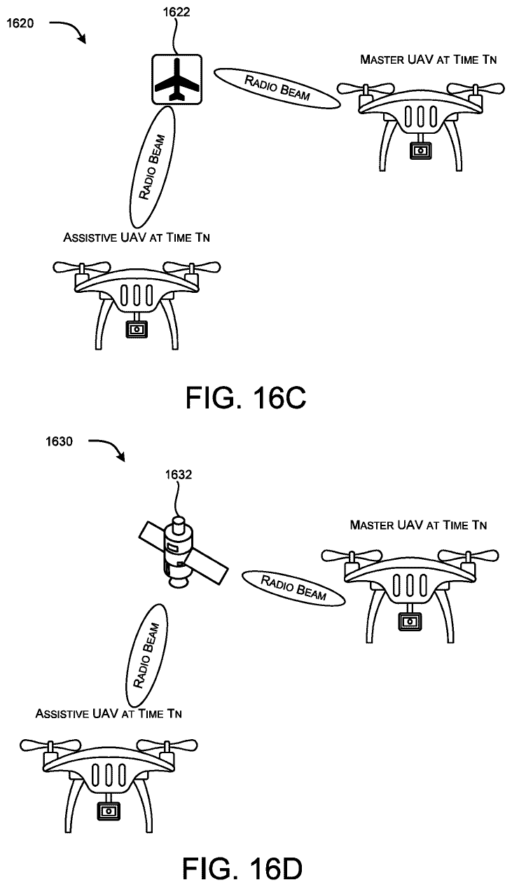

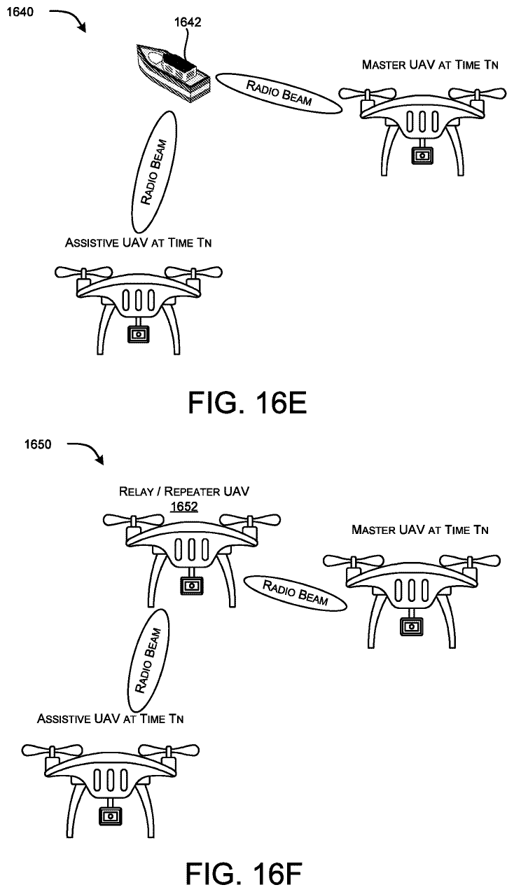

FIGS. 16A-16F illustrate examples use cases (1600, 1610, 1620, 1630, 1640, 1650) for realizing Inter-RAN node interface between master and assistive UAVs, in accordance with an embodiment of the present disclosure. As shown in examples use case (1600) of FIG. 16A, the inter-RAN node interface between master and assistive UAVs may be realized via the RF radio beam (1602) based on 5G+/6G+/IEEE technologies, in an embodiment. In another embodiment, the inter-RAN node interface between master and assistive UAVs may be realized via the Intelligent Reflective Surfaces (IRS) (1612) assisted radio to address the non-line of sight scenarios, as illustrated in FIG. 16B. In yet another embodiment, the inter-RAN node interface between master and assistive UAVs may be realized via an airplane (1622) assisted RF radio based on 5G+/6G+/IEEE technologies, as illustrated in FIG. 16C. In yet another embodiment, the inter-RAN node interface between master and assistive UAVs may be realized via satellite (1632) assisted RF radio based on Satellite/5G+/6G+/IEEE technologies, as illustrated in FIG. 16D. In yet another embodiment, the inter-RAN node interface between master and assistive UAVs may be realized via a sea vehicle (1642) assisted RF radio based on deep-sea/5G+/6G+/IEEE technologies to address the deep-sea scenarios, as illustrated in FIG. 16E. In yet another embodiment, the inter-RAN node interface between master and assistive UAVs may be realized via another UAV acting as a Relay/Repeater UAV (1652) using the RF radio based on 5G+/6G+/IEEE technologies, as illustrated FIG. 16F.

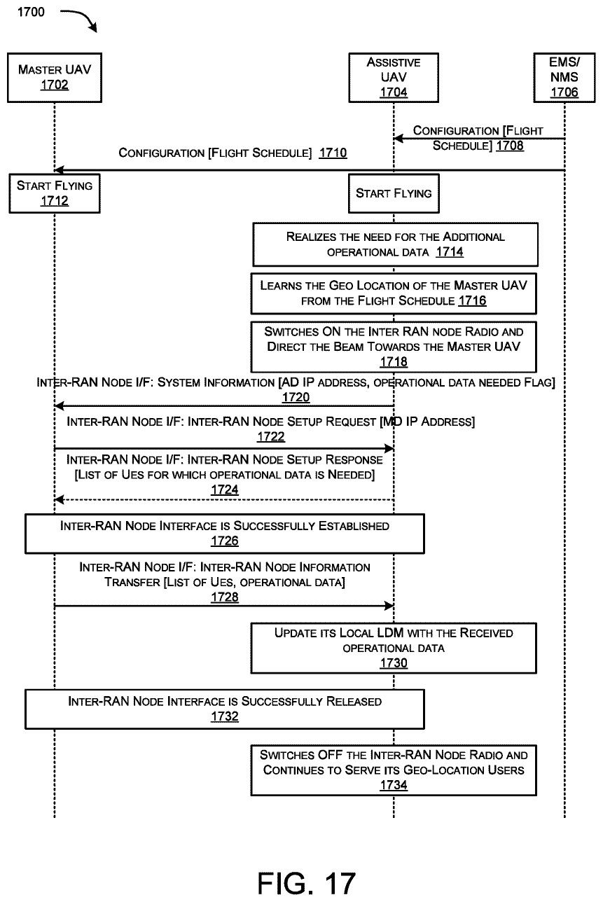

FIG. 17 illustrates a method (1700) for establishing an Inter-RAN node interface between assistive UAV and master UAV, in accordance with an embodiment of the present disclosure.

In an embodiment, the assistive UAV (1704) may decide to connect with the master UAV (1702). FIG. 17 shows the communication and signal flow between the assistive UAV, master UAV and the Element Management System (EMS) or Network Management System (NMS) (1706). The EMS (1706) may configure determine the connection schedule data/flight schedule associated with the assistive UAV (1704) and the master UAV (1702) at steps (1708) and (1710), respectively. The assistive UAV (1704) and the master UAV (1702) may be flying at step (1712). When the assistive UAV (1704) realizes need for additional operational data at step (1714), the assistive UAV (1704) learns the geolocation of the master UAV (1702) from the flight schedule/connection schedule data at step (1716), and switches ON the inter-RAN node interface to radiate the transmission by directing the radio beam (1222) towards the master UAV (1702) at step (1718). The assistive UAV (1704) may broadcast its IP address and a flag indicating the need for the operational data at step (1720), and successfully establishes connection with the inter-RAN node radio interface at step (1726). At steps (1722) and (1724), the master UAV (1702) and the assistive UAV (1704) may exchange inter-RAN node setup requests and responses respectively. In an embodiment, inter-RAN node radio interface may correspond to any one of X2, Xn, or IAB interfaces. Subsequently, the assistive UAV (1704) may receive the needed operational data from the master UAV (1702) at step (1728), and initiates the release of the inter-RAN node connection at step (1732) and switches OFF the inter-RAN node interface at step (1734) to resume serving its users in its geo location.

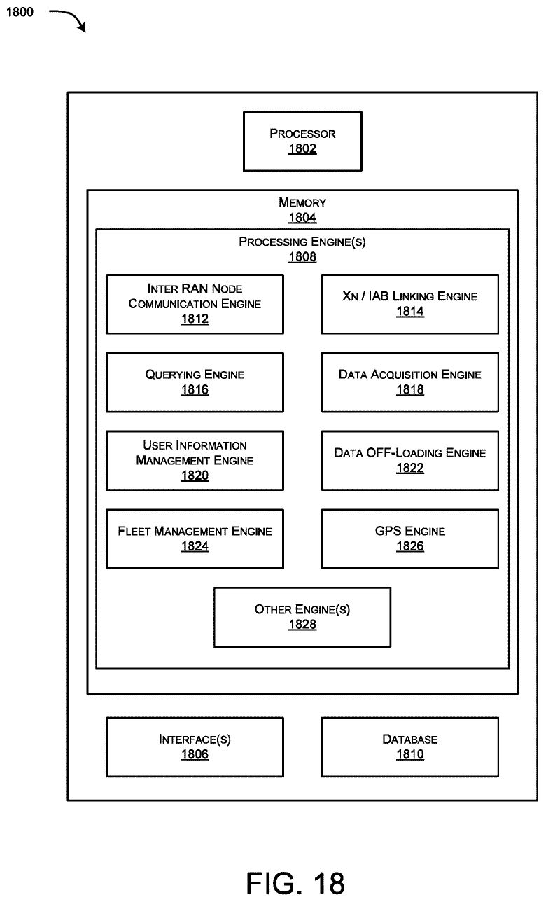

FIG. 18 illustrates an exemplary representation of a proposed system (1800) for providing a 6G coreless architecture, in accordance with an embodiment of the present disclosure. A person of ordinary skill in the art will understand that the system of FIG. 18 may be similar to the NgNB (102) or the master/assistive UAV of FIGS. 2-15 in its functionality.

Referring to FIG. 18, the system (1800) may include one or more processor(s) (1802). The one or more processor(s) (1802) may be implemented as one or more microprocessors, microcomputers, microcontrollers, digital signal processors, central processing units, logic circuitries, and/or any devices that process data based on operational instructions. Among other capabilities, the one or more processor(s) (1802) may be configured to fetch and execute computer-readable instructions stored in a memory (1804) of the system (1800). The memory (1804) may be configured to store one or more computer-readable instructions or routines in a non-transitory computer readable storage medium, which may be fetched and executed to create or share data packets over a network service. The memory (1804) may comprise any non-transitory storage device including, for example, volatile memory such as random-access memory (RAM), or non-volatile memory such as erasable programmable read only memory (EPROM), flash memory, and the like.

In an embodiment, the system may include an interface(s) (1806). The interface(s) (1806) may comprise a variety of interfaces, for example, interfaces for data input and output devices, referred to as input/output (I/O) devices, storage devices, and the like. The interface(s) (1806) may facilitate communication through the system. The interface(s) (1806) may also provide a communication pathway for one or more components of the system. Examples of such components include, but are not limited to, processing engine(s) (1808) and a database (1810).

The processing engine(s) (1808) may be implemented as a combination of hardware and programming (for example, programmable instructions) to implement one or more functionalities of the processing engine(s) (1808). In examples described herein, such combinations of hardware and programming may be implemented in several different ways. For example, the programming for the processing engine(s) (1808) may be processor-executable instructions stored on a non-transitory machine-readable storage medium and the hardware for the processing engine(s) (1808) may comprise a processing resource (for example, one or more processors), to execute such instructions. In the present examples, the machine-readable storage medium may store instructions that, when executed by the processing resource, implement the processing engine(s) (1808). In such examples, the system may comprise the machine-readable storage medium storing the instructions and the processing resource to execute the instructions, or the machine-readable storage medium may be separate but accessible to the system and the processing resource. In other examples, the processing engine(s) (1808) may be implemented by electronic circuitry.

One or more modules/units described with reference to FIG. 6 such as, but not limited to, the management plane (602), L3 Applications (608), Uu stack (610), Core Network Interface (I/F) stack (616), inter RAN Node I/F Stack (618), and L2 Applications (Mac Schedulers) (620) etc. may be implemented as a processing engine. For example, the processing engine(s) (1808) may include an inter RAN node communication engine (1812), an Xn/IAB linking engine (1814), a querying engine (1816), a data acquisition engine (1818), a user information management engine (1820), a downlink/uplink information management engine (1822), a data off-loading engine (1824), a fleet management engine (1826), a Global Positioning System (GPS) engine (1828), other engines (1830), etc. The functions of these engines can be inferred from the ongoing description of FIGS. 1-17 in the context of a UAV/mobile RAN node.

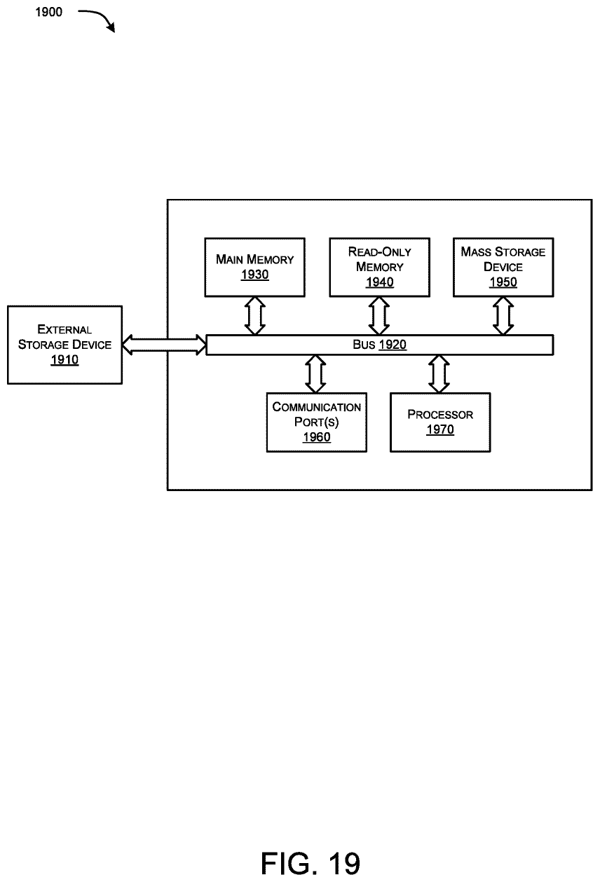

As shown in FIG. 19, the computer system (1900) may include an external storage device (1910), a bus (1920), a main memory (1930), a read-only memory (1940), a mass storage device (1950), a communication port(s) (1960), and a processor (1970). A person skilled in the art will appreciate that the computer system (1900) may include more than one processor and communication ports. The communication port(s) (1960) may be chosen depending on a network, such as a Local Area Network (LAN), Wide Area Network (WAN), or any network to which the computer system (1900) connects. The main memory (1930) may be Random Access Memory (RAM), or any other dynamic storage device commonly known in the art. The read-only memory (1940) may be any static storage device(s) e.g., but not limited to, a Programmable Read Only Memory (PROM) chip for storing static information e.g., start-up or basic input/output system (BIOS) instructions for the processor (1970). The mass storage device (1950) may be any current or future mass storage solution, which can be used to store information and/or instructions.

The bus (1920) may communicatively couple the processor (1970) with the other memory, storage, and communication blocks. Optionally, operator and administrative interfaces, e.g., a display, keyboard, and cursor control device may also be coupled to the bus (1920) to support direct operator interaction with the computer system (1900). Other operator and administrative interfaces can be provided through network connections connected through the communication port(s) (1960). In no way should the aforementioned exemplary computer system (1900) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### ADVANTAGES OF THE PRESENT DISCLOSURE

The present disclosure provides a system and a method for implementing a coreless operation of a RAN node.

The present disclosure provides an approach to implement a mobile RAN node in UAVs and provide network coverage and services using UAVs in a coreless mode.

The present disclosure provides a coreless 6G network architecture for providing network coverage to UEs.

The present disclosure provides an easy and efficient mechanism to offload data from a mobile RAN/UAV when the core network is available to update the change in UE context data.

We claim:

1. A system for broadcasting connection status between Radio Access Network (RAN) node and core network (CN), comprising:
one or more processors; and
a memory operatively coupled to the one or more processors, the memory having one or more processor-executable instructions, which, when executed, cause the one or more processors to:
retrieve a connection schedule data indicative of a schedule of when the system connects to a CN; and
periodically broadcast the connection schedule data in a set of dedicated signals to one or more user equipment (UEs) (104).

2. The system as claimed in claim 1, wherein the set of dedicated signals is transmitted in either System Information Block (SIB) or Master Information Block (MIB) format.

3. The system as claimed in claim 1, wherein the set of dedicated signals is transmitted using a Radio Resource Control (RRC) protocol.

4. The system as claimed in claim 1, wherein the one or more processors are configured to transmit the set of dedicated signals in response to a set of request signals received from the one or more UEs (104).

5. A method for communication between one or more Radio Access Network (RAN) nodes, comprising:
determining, by a RAN node, a first geolocation corresponding to a master RAN node;
transmitting, by the RAN node, a set of request signals to the master RAN node to retrieve operational data required to provide services to one or more User Equipment (UEs) (104);
receiving, by the RAN node, a set of response signals containing the operational data from the master RAN node; and
processing, by the RAN node, the operational data to provide the services to the one or more UEs (104).

6. The method as claimed in claim 5, comprising establishing. by the RAN node, a communication channel with the master RAN node, wherein the communication channel is indicative of a Radio Resource Control (RRC) connection.

7. The method as claimed in claim 5, comprising moving the RAN node to the first geolocation corresponding to the master RAN node from a second geolocation when the second geolocation is within a predetermined distance from the first geolocation. and when the operational data is unavailable at the RAN node.

8. The method as claimed in claim 7, comprising moving the RAN node from the first geolocation to the second geolocation after receiving the operational data requested in the set of request signals.

9. A method for exchanging operational data between a Corc Network (CN) (1506) and a Radio Access Network (RAN) node, comprising:
determining, by a RAN node, if the RAN node is connected to the CN;
transmitting, by the RAN node, a set of update signals having operational data associated with one or more User Equipment (UEs) (104) to the CN, wherein the operational data comprises UE contexts associated with each of the one or more UEs (104);
receiving, by the RAN node, a set of verification signals from the CN, the set of verification signals having a set of verified UEs (104) from the one or more UEs (104) successfully authenticated by the CN;
establishing, by the RAN node, a session for each UE in the set of verified UEs; and
exchanging, by the RAN node, the operational data associated the set of verified UEs (104) to the CN.

10. The method as claimed in claim 9, comprising blacklisting, by the RAN node, UEs from the one or more UEs (104) rejected by the CN, wherein the rejected UEs are deleted from the UE contexts.

11. The method as claimed in claim 9, wherein the RAN node comprises a LW-Access Management Function (AMF) and a LW-User Plane Function (UPF), and for offloading cached operational data, the method comprises:
transmitting, by the LW-AMF, a data transfer signal to the LW-UPF; and
transmitting, by the LW-UPF, the operational data cached in a local CN user plane cache (906) to the CN (1506).

12. The method as claimed in claim 11, comprising causing, by the RAN node, the CN to forward the cached operational data to a Data Network.

13. A Radio Access Network (RAN) node for providing services to User Equipment (UEs) (104), comprising:
a Uu stack (610) having a Radio Frequency (RF) unit (612) configured to exchange radio signals with one or more UEs (104) that request services from the RAN node;
an inter-RAN node interface (624) configured to communicate with other RAN nodes; and
a local Core Network (CN) configured to process operational data associated with the one or more UEs (104) and communicate with the one or more UEs (104) using the Uu stack (610) to provide services requested by the one or more UEs (104), wherein the local CN is configured to communicate with the other RAN nodes using the inter-RAN node interface (624) to exchange the operational data required to provide the services to the one or more UEs (104).

14. The RAN node as claimed in claim 13, wherein the local CN comprises:
a local CN control plane (CP) (902) configured to process the operational data to provide the services to the one or more UEs (104); and
a local CN user plane (UP) (904) configured to receive and transmit the operational data between the local CN CP (902) of the RAN node, and the one or more UEs (104), other RAN nodes, or a CN.

15. The RAN node as claimed in claim 13, comprising a local CN user plane (UP) cache (906) configured to store the operational data for providing the services to the one or more UEs (104), and wherein when the operational data required for providing the services to the one or more UEs (104) is unavailable at the local CN UP cache (906), the RAN node is configured to retrieve the unavailable operational data from a master RAN node having a fully updated database of operational data and store the operational data in the local CN CP cache (906).

16. The RAN node as claimed in claim 13, wherein when the RAN node is a master RAN node, the RAN node has a fully updated database of operational data, and wherein the RAN node is configured to:
receive an operational data request from one or more assistive RAN nodes for retrieving the operational data associated with the one or more UEs (104);
retrieve the operational data requested by the one or more assistive RAN nodes from the fully updated database of operational data; and
transmit the requested operational data in an operational data response to the one or more assistive RAN nodes.

17. The RAN node as claimed in claim 13, wherein the RAN node is configured to transmit, by the Uu stack (610), an operational data request to a master RAN node using a directed radio beam when the operational data required for providing the services to the one or more UEs (104) in unavailable at the RAN node.

18. The RAN node as claimed in claim 13, wherein the inter-RAN node interface (624) of the RAN node and inter RAN interfaces of the other RAN nodes exchange an operational data request and an operational data response via a Radio Resource Control (RRC) protocol.

19. The RAN node as claimed in claim 13, comprising a transportation means configured to allow the RAN node to move from a first geolocation to a second geolocation, wherein the local CN is configured to cause the RAN node to move from the first geolocation to the second geolocation when the RAN node is in the first geolocation and requires the operational data available at other RAN nodes at the second geolocation.

20. The RAN node as claimed in claim 13, comprising a management plane (602) having:
a Local Dynamic Map (LDM) (604) configured to store any of: topographical, positional, and status data associated with a geographical region; and
a management interface (606) configured to transmit and receive the LDM data, wherein the management plane (602) is configured to determine availability of other RAN nodes.

21. The RAN node as claimed in claim 20, wherein the management plane (602) is configured to determine if a master RAN node is within a predetermined threshold distance from the RAN node using the data stored in the LDM (604).

22. The RAN node as claimed in claim 13, comprising a CN interface (I/F) (616) configured to operably connect and communicate with the CN when the RAN node is connected thereto, wherein the RAN node is configured to transmit or receive the operational data from the CN.

23. The RAN node as claimed in claim 22, wherein the RAN node, using the CN interface (616), is configured to:
transmit a set of update signals having the operational data associated with the one or more UEs (104) to the CN, wherein the operational data comprises UE contexts associated with each of the one or more UEs (104);
receive a set of verification signals from the CN, the set of verification signals having a set of verified UEs (104) from the one or more UEs (104) successfully authenticated by the CN;
establish a session for each UE in the set of verified UEs (104); and
exchange the operational data associated with the set of verified UEs (104) to the CN.

24. The RAN node as claimed in claim 14, wherein the local CN CP (902) comprises a Security Edge Protection Proxy (SEPP) configured to:
validate identity of the other RAN nodes with which communication is sought; and
on successful validation, establish a communication channel between the RAN node and the other RAN nodes, wherein the communication channel is any one of: a Xn interface, or an Integrated Access Backhaul (IAB) interface.

25. A user equipment (UE) (104), comprising:
one or more processors; and
a memory operatively coupled to the one or more processors, the memory having one or more processor-executable instructions, which, when executed, cause the one or more processors to:
receive a set of dedicated signals from a Radio Access Network (RAN) node; and
establish a communication channel with the RAN node based on connection schedule data provided in the set of dedicated signals.

26. The UE (104) as claimed in claim 25, wherein the one or more processors are configured to transmit a set of request signals to the RAN node, and wherein the set of dedicated signals from the RAN node is received in response to the set of request signals.

27. The UE (104) as claimed in claim 25, wherein the one or more processors are configured to select a protocol for communicating with the RAN node based on the set of dedicated signals.

28. A Security Edge Protection Proxy (SEPP) system, comprising:
a Radio Access Network (RAN) node, each having one or more processors,
a memory operatively coupled to the one or more processors, the memory having one or more processor-executable instructions, which, when executed, cause the one or more processors to:
validate identity of other RAN nodes with which communication is sought; and
on successful validation, establish a communication channel between the RAN node and the other RAN nodes.

29. The SEPP system as claimed in claim 28, wherein the communication channel is any one of: Xn interface, or an Integrated Access Backhaul (IAB) interface.

30. A non-transitory computer-readable medium comprising processor-executable instructions that cause a processor to:
determine a first geolocation corresponding to a master Radio Access Network (RAN) node;
transmit a set of request signals to the master RAN node to retrieve operational data required to provide services to one or more User Equipment (UEs) (104);
receive a set of response signals containing the operational data from the master RAN node; and
process the operational data to provide the services to the one or more UEs (104).
